(19) United States
(12) Patent Application Publication
(10) Pub. No.: US 2010/0208170 A1
(43) Pub. Date: Aug. 19, 2010

(54) SURFACE LIGHT SOURCE DEVICE AND LIQUID CRYSTAL DISPLAY DEVICE

(75) Inventors: Yasuhiro Tanoue, Shiga (JP); Masayuki Shinohara, Shiga (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi, Kyoto (JP)

(21) Appl. No.: 12/674,576

(22) PCT Filed: Aug. 7, 2008
(86) PCT No.: PCT/JP2008/064245

§ 371 Date: Apr. 22, 2010

(30) Foreign Application Priority Data
Oct. 29, 2007 (JP) 2007-280448

(51) Int. Cl. G02F 1/13357; F21V 7/04

(52) U.S. Cl. 349/65; 362/620

(57) ABSTRACT

A surface light source device has a surface-shaped light source having a light emission surface, a first prism sheet at a side of the light emission surface, and a second prism sheet in an opposite side from the surface-shaped light source with the first prism sheet interposed therebetween. The first prism sheet includes prisms having a greater length in a longitudinal direction and having an apical angle between 72 and 100 degrees which are arranged on a surface facing the surface-shaped light source. The second prism sheet includes prisms having a greater length in a longitudinal direction and having an apical angle between 100 and 125 degrees which are arranged on a surface facing a direction opposite the surface-shaped light source. The first and second prism longitudinal direction form an angle of 15 degrees or less, when the first and second prism sheet are viewed in a perpendicular direction.

### TECHNICAL FIELD

The present invention relates to a surface light source device and a liquid crystal display device.

### BACKGROUND ART

Car navigation systems which give instructions on destinations of cars have been widely used, and as illustrated in FIG. 1, an in-car monitor 100 in such a car navigation system is installed on the dashboard 103 between the driving seat 101 and the passenger seat 102 in the car. Further, such a car navigation system is used during driving the car at any time during the day or night and, further, the in-car monitor may be also viewed from the passenger seat or the rear seats (particularly, in cases where it is capable of displaying DVD images). Therefore, car navigation systems are required to have performance as follows.

1. The in-car monitors should be bright and clear when they are viewed either from the portion in front thereof or from the driving seat or the passenger seat.

2. The in-car monitors prevent reflection thereof on the front glass, which would obstruct the field of view, during driving at night.

In ordinary vehicles (normal cars), an in-car monitor 100 installed at the center of the dash board 103 is viewed from the driving seat 101 and the passenger seat 102 in leftward and rightward directions at an angle of about 30 degrees respectively with respect to the direction perpendicular to the screen of the in-car monitor 100. Further, the area in the forward direction perpendicular to the screen of the in-car monitor 100 and the areas in the leftward and rightward directions at about 30 degrees respectively will be comprehensively referred to as an irradiation area V.

Further, as illustrated in FIG. 2, assuming that the in-car monitor is installed such that a normal line N erected on the screen of the in-car monitor 100 is directed toward the eyes of the driver when viewed in the lateral direction, light inclined upwardly by 50 degrees or more with respect to the normal line N on the screen is reflected by the front glass 104 and then enters the driver eyes, thereby obstructing the driving. Further, such light emitted in this direction may be referred to as side lobe light, in some cases.

Accordingly, the surface light source device used in the liquid crystal display device in such an in-car monitor 100 is desired to have such characteristics as to have brightness in an area in the forward direction and areas in leftward and rightward directions at about 30 degrees, while emitting no light toward areas in upward directions at 50 degrees or more.

FIG. 3 is a diagram illustrating a directivity characteristic of a surface light source device. The center of the directivity characteristic diagram indicates the direction perpendicular to the light emission surface of the surface light source device (which is referred to as a Z direction), plural concentric circles indicate inclinations with respect to the Z direction, in steps of 10 degrees, up to 90 degrees (they indicate these inclinations as angles φ with respect to the Z direction), and radial straight lines about the Z direction indicate angles in the range of 0 degrees to 360 degrees. Further, an X direction indicates the direction in which the surface light source device is incorporated in an apparatus such that it is oriented in a lateral direction in installation, while a Y direction indicates the direction in which the surface light source device is installed such that it is oriented in a longitudinal direction (an upward/downward direction, or an oblique upward/downward direction inclined forwardly or rearwardly) in installation. As a preferable characteristic of the in-car monitor, in this directivity characteristic diagram, the observation area required to have a high light intensity is a center area and areas in leftward and rightward directions at about 30 degrees along the X direction (hereinafter, these areas will be referred to as an irradiation area V). Further, the area required to emit a small amount of light, since such emitted light may reflect on the front glass, is areas at 50 degrees or more along the Y direction, as enclosed by a dotted line in FIG. 3 (hereinafter, the area will be referred to as a non-irradiation area W).

The inventors of the present invention conducted studies for directivity characteristics of conventional surface light source devices, in view of the aforementioned perceptions.

### First Prior-Art Example

FIG. 4 is a cross-sectional view illustrating the structure of a surface light source device having standard characteristics. The surface light source device 110 is one which a patent literature 5 has introduced, in FIG. 25(B), as a surface light source device according to a patent document 1. The surface light source device 110 includes a translucent substrate 111, an optical isotropic diffusion layer 112 formed on one surface of the translucent substrate 111, a prism sheet 113 laminated thereon, and a reflection layer 114 formed on the other surface thereof. Further, a dot-shaped or line-shaped light source 115 is placed on a side surface of the translucent substrate 111. The prism sheet 113 is constituted by an arrangement of unit prisms having a triangular prism shape with an apical angle of 90 degrees, and these unit prisms are placed such that they are faced toward the opposite side from the translucent substrate 111.

The surface light source device 110 is described as being adapted such that, light is isotropically diffused by the optical isotropic diffusion layer 112 and then is polarized by the prism effect of the prism sheet 13, which concentrates optical energy near the vertical direction, thereby increasing the efficiency of utilization of light.

Therefore, the inventors of the present invention determined, through simulations, directivity characteristics of the surface light source device 110 in FIG. 4. For the simulations, as illustrated in FIG. 5, they employed a model including light sources 116 having a Lambert characteristic which are placed such that a plurality of light sources 116 are arranged in both an X direction and a Y direction in a grid shape, and the prism sheet 113 in the surface light source device 110 which is placed thereon such that the prism longitudinal direction is parallel with the X direction and the direction of the prism arrangement is parallel with the Y direction. Further, in FIG. 5, a smaller number of light sources 116 are illustrated, but about 1000,000 light sources were placed for performing the simulations, in order to form the model of the surface light source device with the emission surface with excellent accuracy. FIG. 6 is a directivity characteristic diagram illustrating the results of simulations. Further, FIG. 7 is a view illustrating the directivity characteristic (a narrow line) in the lateral direction (in the ZX plane) and the directivity characteristic (a thick line) in the longitudinal direction (in the YZ plane). In FIG. 7, it is assumed that the light intensity in the Z direction is 1, and angles φ in the positive directions in the X and Y directions are indicated by positive values, but angles φ in the negative directions are indicated by negative values.

Referring to FIG. 6 and FIG. 7, the directivity characteristic in the lateral direction is spread over the irradiation area V. However, in the irradiation areas V in the leftward and rightward directions at 30 degrees (φ=±30 degrees), the light intensity is reduced to about 80% in comparison with the light intensity in the Z direction (φ=0 degrees), and it can not be said that the light intensity is sufficient. Further, referring to the directivity characteristic in the longitudinal direction, the light intensity becomes excessively higher in the area at 45 degrees or more. Therefore, the light intensity in the non-irradiation area W is high. When the surface light source device 110 is used as an in-car monitor, light therefrom reflects on the front glass significantly strongly.

Hereinafter, comparisons will be made between one or more embodiments of the present invention and respective prior-art examples, by using the directivity characteristics of the surface light source device 110 as a reference.

### Second Prior-Art Example

FIG. 8 is a perspective view illustrating a prism sheet 120 used in a surface light source device disclosed in a patent document 2. The prism sheet 120 includes unit prisms 121 placed such that they are faced toward the opposite side from the translucent substrate. The unit prisms 121 have an apical angle α which is equal to or larger than 95 degrees but equal to or smaller than 110 degrees, in order to reduce the intensity of light emitted to the non-irradiation area W.

Therefore, simulations were conducted under the same conditions as those of the first prior-art example, using the prism sheet 120 in FIG. 8 having an apical angle of 95 degrees and 110 degrees. FIG. 9 is a directivity characteristic diagram illustrating the results of simulations assuming that the apical angle is 95 degrees. Further, FIG. 10 is a view illustrating the directivity characteristic (a narrow line) in the lateral direction (in the ZX plane) and the directivity characteristic (a thick line) in the longitudinal direction (in the YZ plane), in this case. In this case, in FIG. 10, it is assumed that the light intensity is 1 in the Z direction according to the first prior-art example (also, the amount of light on the prism sheet is normalized such that it is the same value as that in the first prior-art example, and the same will be applied hereinafter).

Referring to FIG. 9 and FIG. 10, the light intensity in the irradiation area V positioned in the Z direction (the front-surface intensity) is reduced by 5% from that in the first prior-art example. Further, regarding the directivity characteristic in the lateral direction, in the irradiation areas V in the leftward and rightward directions at 30 degrees, the light intensity is reduced to about 80% in comparison with the light intensity in the Z direction same as the first prior-art example, and it can not be said that the light intensity is sufficient. Further, referring to the directivity characteristic in the longitudinal direction, the light intensity in the areas at 45 degrees or more is reduced in comparison with the first prior-art example, but there is still emission of a large amount of light to the non-irradiation area W. Therefore, when it is used as an in-car monitor, the light will reflect on the front glass.

FIG. 11 is a directivity characteristic diagram illustrating the results of simulations assuming that the apical angle α is 110 degrees. Further, FIG. 12 is a view illustrating the directivity characteristic (a narrow line) in the lateral direction (in the ZX plane) and the directivity characteristic (a thick line) in the longitudinal direction (in the YZ plane), in this case.

Referring to FIG. 11 and FIG. 12, the directivity is spread in the lateral direction and, therefore, the light intensity in the irradiation area V positioned in the Z direction is reduced by 20% from that in the first prior-art example. Further, regarding the directivity characteristic in the lateral direction, the light intensity in the irradiation areas V in the leftward and rightward directions at 30 degrees is about 85% in comparison with the light intensity in the Z direction. Regarding the directivity characteristic in the longitudinal direction, the light intensity in the areas at 50 degrees or more is largely reduced, thereby attaining significant improvement about the amount of light emitted to the non-irradiation area W.

As described above, in the case of the second prior-art example, if the apical angle α is made closer to 95 degrees, this reduces the amount of light emitted to the irradiation area V to degrade the visibility of images and, also, increases the amount of light emitted to the non-irradiation area W, which tends to cause light and images to reflect on the front glass. Further, if the apical angle α is made closer to 110 degrees, this can attain large improvement about the amount of light emitted to the non-irradiation area W, but largely reduces the amount of light emitted to the irradiation area V, which may result in large degradation of the visibility of the liquid crystal display device.

### Third Prior-Art Example

FIG. 13 is a schematic view of a surface light source device 130 described in a patent literature 3. The surface light source device 130 includes a surface-shaped light source 131, a prism sheet 132 overlaid on the front surface of the surface-shaped light source 131, and an optical sheet 133 laminated on the front surface thereof. The prism sheet 132 is constituted by an arrangement of unit prisms having an apical angle of 90 degrees, and its surface provided with the unit prisms is faced to the surface-shaped light source 131.

This surface light source device is described as being capable of providing high brightness in both the directions toward the driving seat and the passenger seat, when it is installed at a portion between the driving seat and the passenger seat as an in-car monitor in a car navigation system.

Therefore, simulations were conducted under the same conditions as those in the first prior-art example, using the prism sheet 132. In this case, as illustrated in FIG. 14, the prism sheet 132 is placed such that the direction of the prism arrangement is parallel with the X direction, and the prism longitudinal direction is parallel with the Y direction. FIG. 15 is a directivity characteristic diagram illustrating the results of simulations, in this case. Further, FIG. 16 is a view illustrating the directivity characteristic (a narrow line) in the lateral direction (in the ZX plane) and the directivity characteristic (a thick line) in the longitudinal direction (in the YZ plane), in this case.

Referring to FIG. 15 and FIG. 16, regarding the lateral direction, light is emitted to the irradiation areas V positioned in the leftward and rightward directions at 30 degrees, but no light is emitted in the Z direction, and the light intensity in the irradiation area V positioned in front thereof (the front-surface intensity) is substantially zero. Further, referring to the directivity characteristic in the YZ plane, no light is emitted in the YZ plane at all, and no light is emitted to the non-irradiation area W, but no light is emitted to the irradiation area V in the forward direction at all, similarly.

In order to emit light to the irradiation area V in the forward direction, it is necessary to place a diffusion sheet and the like prior to the prism sheet 132 for strongly diffusing light. However, by doing this, light is also emitted to the non-irradiation area W, which makes it impossible to prevent reflection on the front glass.

### Fourth Prior-Art Example

FIG. 17 is a schematic view illustrating the structure of a liquid crystal display device 140 described in a patent literature 4. The liquid crystal display device 140 includes a surface-shaped light source 141, a louvered film 142 laminated on the front surface of the surface-shaped light source 141, and a liquid crystal display panel 143 placed on the front surface thereof. The louvered film 142 has a fine louver structure and can be, for example, a “Light Control Film” manufactured by Sumitomo 3M limited. By using the louvered film 142, it is possible to restrict the direction of light transmission and the spread of light in the direction of the louver arrangement.

FIG. 18 is a view illustrating a directivity characteristic (a thick line) of the surface light source device in the liquid crystal display device 140 from which the liquid crystal display panel 143 has been eliminated, and a directivity characteristic (a narrow line) of the surface light source device from which the louvered film 142 has been further eliminated. As can be seen from FIG. 18, in the case of using the louvered film 142, the light intensity is substantially zero at angles equal to or more than 35 degrees and, therefore, no light is emitted to the non-irradiation area W, thereby preventing the reflection on the front glass.

However, since the louvered film 142 has a low transmittance, the light intensity in the vertical direction (the Z direction) is reduced by 20 to 30%, in comparison with cases where the louvered film 142 is not used, thereby making the entire irradiation area V significantly dark. Further, such a louvered film is expensive, which necessitates a cost equivalent to that of ten or more prism sheets.

### Fifth Prior-Art Example

FIG. 19 is a pair of prism sheets 151 and 152 which are described in a patent literature 5. One prism sheet 151 is placed such that its surface provided with unit prisms is oriented toward a surface-shaped light source, while the other prism sheet 152 is placed in the opposite side from the surface-shaped light source such that its surface provided with unit prisms is oriented toward the opposite side from the surface-shaped light source. The prism longitudinal directions of both the prism sheets 151 and 152 are parallel with each other. Further, these prism sheets 151 and 152 are characterized in that the apical angle of the unit prisms satisfies the following, assuming that the critical angle of the prism sheet material for total reflection is θc.

α<2*θc

This enables the surface light source device to have a higher luminance. Further, the patent document 5 describes that the use of the pair of prism sheets 151 and 152 having the aforementioned structure can prevent the occurrence of side lobe light, and this effect is prominent, in the case where the unit prisms satisfy the inequality α<90 degrees (particularly, a approximately equals to 60 degrees).

However, simulations were conducted using the pair of prism sheets 151 and 152 to obtain results as in FIG. 20 and FIG. 21. FIG. 20 is a directivity characteristic diagram illustrating the results of simulations assuming that the apical angle α is 60 degrees. Further, FIG. 21 is a view illustrating the directivity characteristic (a narrow line) in the lateral direction (in the ZX plane) and the directivity characteristic (a thick line) in the longitudinal direction (in the YZ plane), in this case. Further, in the simulations, light sources having Lambert characteristics were placed such that a plurality of these light sources are arranged in both an X direction and a Y direction in a grid shape, and the prism sheets 151 and 152 were placed thereon, such that the prism longitudinal direction was parallel with the X direction, and the direction of the prism arrangement was parallel with the Y direction (see FIG. 5).

Referring to FIG. 20 and FIG. 21, the light intensity in the irradiation area V positioned in the Z direction (the front-surface intensity) is reduced by 20% from that in the first prior-art example. Further, regarding the directivity characteristic in the lateral direction, in the irradiation areas V in the leftward and rightward directions at 30 degrees, the light intensity is reduced to about 50% in comparison with the light intensity in the Z direction, and the light intensity is insufficient. Further, referring to the directivity characteristic in the longitudinal direction, the light intensity in the non-irradiation area W is increased from that in the first prior-art example. Therefore, when it is used as an in-car monitor, the light reflects on the front glass intensively.

Patent Document 1: Japanese Unexamined Patent Publication No. 63-318003

Patent Document 2: Japanese Unexamined Patent Publication No. 2001-124910

Patent Document 3: Japanese Unexamined Patent Publication No. 2000-164016

Patent Document 4: Japanese Unexamined Patent Publication No. 06-504627

Patent Document 5: Japanese Unexamined Patent Publication No. 6-222207

### SUMMARY OF INVENTION

One or more embodiments of the present invention provides a surface light source device having a directivity characteristic flattened in a single direction.

In accordance with one aspect of the present invention, there is provided a surface light source device including a surface-shaped light source which emits light from a light emission surface, a first prism sheet placed at a side of the light emission surface of the surface-shaped light source, and a second prism sheet placed in the opposite side from the surface-shaped light source with the first prism sheet interposed therebetween, wherein the first prism sheet includes prisms having a greater length in one direction and having an apical angle equal to or more than 72 degrees but equal to or less than 100 degrees which are arranged on its surface faced to the surface-shaped light source, the second prism sheet includes prisms having a greater length in one direction and having an apical angle equal to or more than 100 degrees but equal to or less than 125 degrees which are arranged on its surface faced in the opposite direction from the surface-shaped light source, and the prism longitudinal direction of the first prism sheet and the prism longitudinal direction of the second prism sheet form an angle of 15 degrees or less, when the first prism sheet and the second prism sheet are viewed in the direction perpendicular thereto.

With the first surface light source device according to one or more embodiments of the present invention, the first prism sheet includes prisms having a greater length in one direction and having an apical angle equal to or more than 72 degrees but equal to or less than 100 degrees which are arranged on its surface faced to the surface-shaped light source. Accordingly, in a plane perpendicular to the prism longitudinal direction, light emitted from the light emission surface of the surface light source device is refracted when passing through the first prism sheet and, thus, is hardly emitted in the direction perpendicular to the light emission surface. For example, when the prism apical angle in the first prism sheet is 90 degrees, substantially no light is emitted in directions at 10 degrees or less with respect to the vertical direction.

Accordingly, there is hardly light incident to the second prism sheet in the vertical direction, in the plane perpendicular to the prism longitudinal direction. Furthermore, the second prism sheet includes prisms having a greater length in one direction and having an apical angle equal to or more than 100 degrees but equal to or less than 125 degrees which are arranged on its surface facing in the opposite direction from the surface-shaped light source. Further, the second prism sheet is placed such that its prism longitudinal direction forms an angle of 15 degrees or less with the prism longitudinal direction of the first prism sheet, when it is viewed in the vertical direction. Accordingly, in a plane perpendicular to the prism longitudinal direction, there is hardly light incident to the second prism sheet in the vertical direction, thereby preventing emission of light (side-lobe light) in directions at angles equal to or more than a certain angle with respect to the vertical direction. For example, in the case where the prism apical angle in the second prism sheet is 112 degrees, there is hardly light emission to areas at 45 degrees or more with respect to the vertical direction. Further, light incident to the second prism sheet at a certain inclination angle is refracted by the second prism sheet and, thus, is emitted from the second prism sheet in the vertical direction.

On the other hand, in a plane perpendicular to the direction of the prism arrangement, light is less subjected to optical effects of the first and second prism sheets and, therefore, is emitted from the second prism sheet with a spread equivalent to the spread of the directivity characteristic of the surface-shaped light source. As a result, light emitted from the surface light source device has a flat directivity characteristic which is widened in the prism longitudinal direction but is narrowed in the direction of the prism arrangement.

The first surface light source device according to one or more embodiments of the present invention has an area with a higher light intensity which is elongated in a single direction (the prism longitudinal direction) as described above, and, in the direction orthogonal thereto, there is hardly light emission in directions at angles with certain magnitudes with respect to the vertical direction. Accordingly, when it is used as an in-car monitor and is installed such that the prism longitudinal direction is oriented in the lateral direction, the in-car monitor can be viewed clearly from the driving seat, the passenger seat and the rear seats and, furthermore, images and light from the in-car monitor are prevented from reflecting on the front glass to obstruct the driving.

In the above aspect, the surface-shaped light source has such a directivity characteristic as to spread light emitted from its light emission surface. With this embodiment, due to the use of the surface-shaped light source having an entirely-spread directivity characteristic, it is possible to largely widen the directivity characteristic of light emitted from the surface light source device in the prism longitudinal direction. This can widen the directivity characteristic in the lateral direction, thereby making the entire irradiation area bright.

In the above aspect, the first prism sheet and the second prism sheet include prisms each having a refractive index of 1.55 or more. By forming the prisms from a material having a refractive index equal to or higher than 1.55, it is possible to increase the effect of condensing light passed through the first and second prism sheets, thereby reducing side-lobe light.

In accordance with another aspect of the present invention, there is provided a surface light source device including a surface-shaped light source which emits light from a light emission surface and a prism sheet placed at a side of the light emission surface of the surface-shaped light source, wherein the surface-shaped light source emits, from its light emission surface, light having such a directivity characteristic as to have a peak in a direction which forms an angle larger than 10 degrees with the direction perpendicular to the light emission surface, in a plane perpendicular to the light emission surface, and the prism sheet includes prisms having a greater length in one direction and having a refractive index of 1.55 or more and an apical angle equal to or more than 100 degrees but equal to or less than 125 degrees which are arranged on its surface faced in the opposite direction from the surface-shaped light source, and the prism sheet is placed such that its prism longitudinal direction is oriented in the direction perpendicular to the plane perpendicular to the light emission surface.

With the second surface light source device according to one or more embodiments of the present invention, there is hardly light emission in the range equal to or less than 10 degrees with respect to the direction perpendicular to the light emission surface, in a plane perpendicular to the light emission surface of the surface-light source device. Accordingly, there is hardly light incident to the prism sheet in the range equal to or less than 10 degrees with respect to the vertical direction, in a plane perpendicular to the prism longitudinal direction. Further, the prism sheet includes prisms having a greater length in one direction and having a refractive index of 1.55 or more and an apical angle equal to or more than 100 degrees but equal to or less than 125 degrees which are arranged on its surface facing in the opposite direction from the surface-shaped light source. Therefore, in the plane perpendicular to the prism longitudinal direction, there is hardly light incident to the prism sheet in the vertical direction, which prevents emission of light (side-lobe light) in directions at angles equal to or more than a certain angle with respect to the vertical direction. For example, when the prism apical angle in the prism sheet is 112 degrees, there is hardly light emission to areas at 45 degrees or more with respect to the vertical direction. Further, since the prisms have a refractive index equal to or higher than 1.55, it is possible to increase the effect of condensing light passed through the prism sheet, thereby reducing side-lobe light. Further, light incident to the prism sheet at a certain inclination angle is refracted by the prism sheet and, thus, is emitted from the prism sheet in the vertical direction.

On the other hand, in a plane perpendicular to the direction of the prism arrangement, light is less subjected to optical effects of the prism sheet and, therefore, is emitted from the prism sheet with a spread equivalent to the spread of the directivity characteristic of the surface-shaped light source. As a result, light emitted from the surface light source device has a flat directivity characteristic which is widened in the prism longitudinal direction but is narrowed in the direction of the prism arrangement.

The second surface light source device according to one or more embodiments of the present invention has an area with a higher light intensity which is elongated in a single direction (the prism longitudinal direction) as described above and, in the direction orthogonal thereto, there is hardly light emission in directions at angles with certain magnitudes with respect to the vertical direction. Accordingly, when it is used as an in-car monitor and is installed such that its prism longitudinal direction is oriented in the lateral direction, the in-car monitor can be viewed clearly from the driving seat, the passenger seat and the rear seats and, furthermore, images and light from the in-car monitor are prevented from reflecting on the front glass to obstruct the driving.

In accordance with still another aspect of the present invention, there is provided a liquid crystal display device including a liquid crystal display panel which is placed to be faced to the surface light source device according to the above aspect or another aspect. The surface light source device according to one or more embodiments of the present invention has visibility over a wide range in a single direction while having visibility only in a narrow range in the direction orthogonal thereto. Accordingly, for example, when the liquid crystal display device is used as an in-car monitor in a car navigation system, by installing it such that the direction in which there is visibility over a wider range is oriented in the lateral direction, it is possible to cause the liquid crystal display device to have preferable visibility from the driving seat, the passenger seat and the rear seats and, further, it is possible to prevent images on the in-car monitor from reflecting on the front glass, thereby preventing them from obstructing the driving.

### BRIEF DESCRIPTION OF THE DRAWINGS

FIG. 1 is a schematic view illustrating the inside of a vehicle in which an in-car monitor is installed.

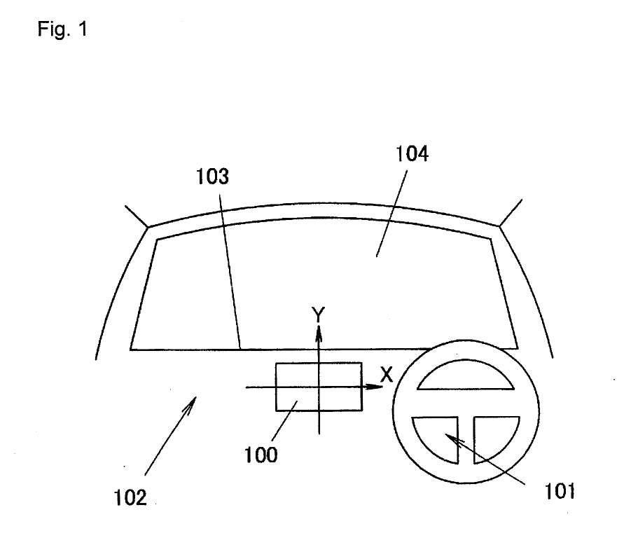

FIG. 2 is a view illustrating a state where light from an in-car monitor is reflected by a front glass and enters the eyes of a driver.

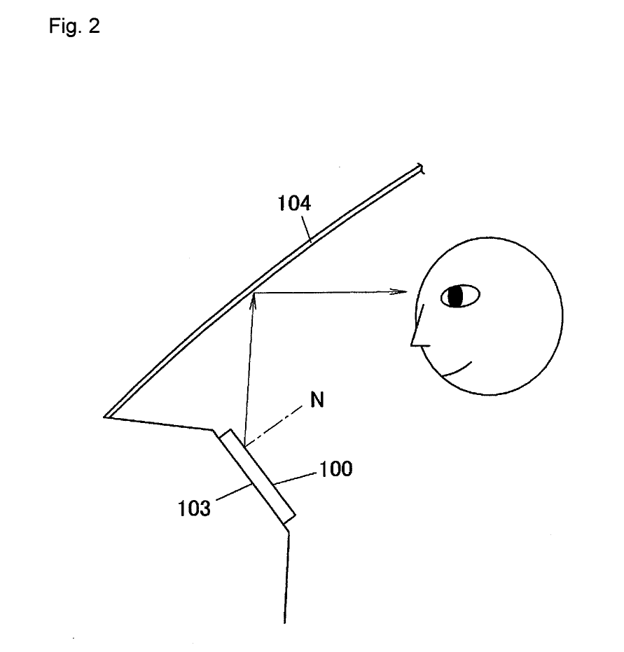

FIG. 3 is a view illustrating a preferable directivity characteristic of a surface light source device.

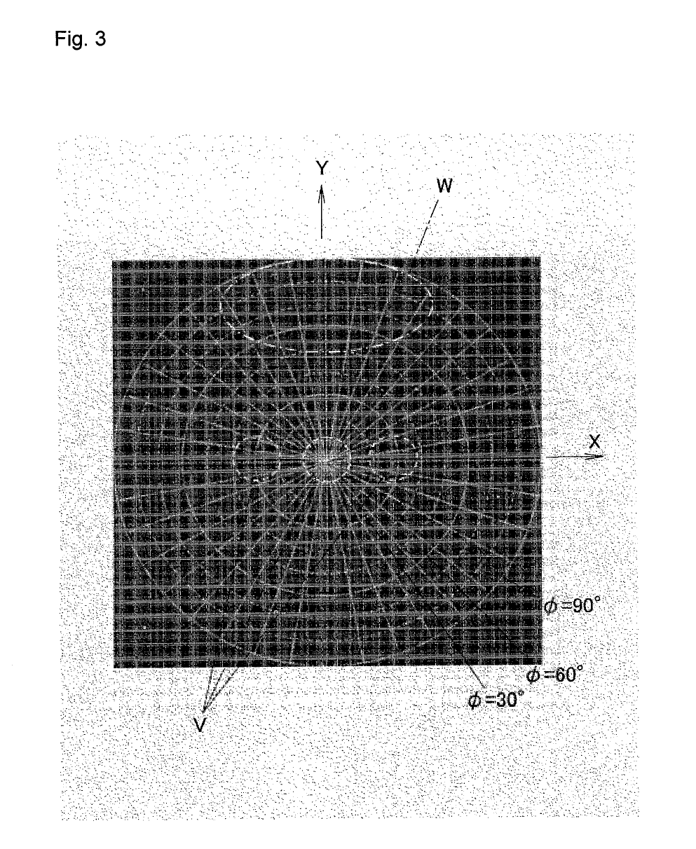

FIG. 4 is a cross-sectional view illustrating the structure of a surface light source device in a first prior-art example.

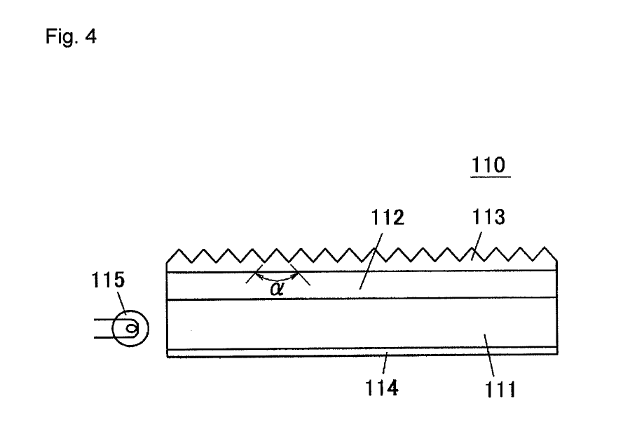

FIG. 5 is a view illustrating a model for determining directivity characteristics of a surface light source device through simulations.

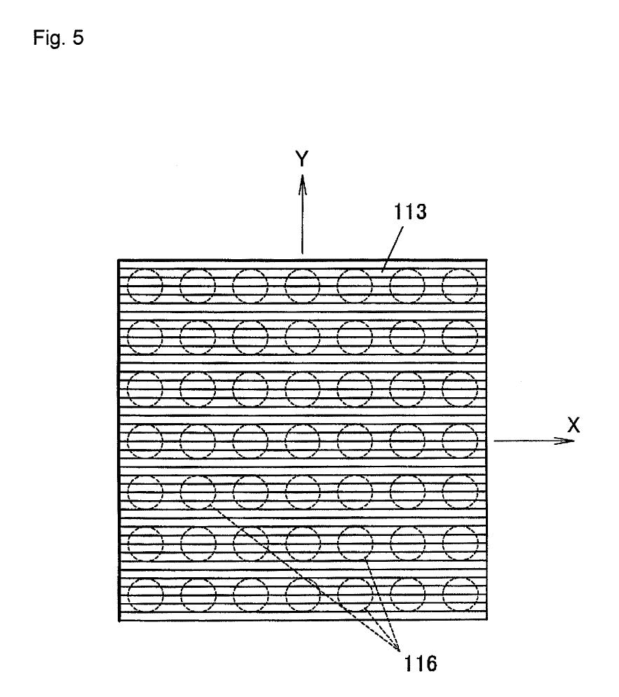

FIG. 6 is a view illustrating the results of simulations for a directivity characteristic of the first prior-art example.

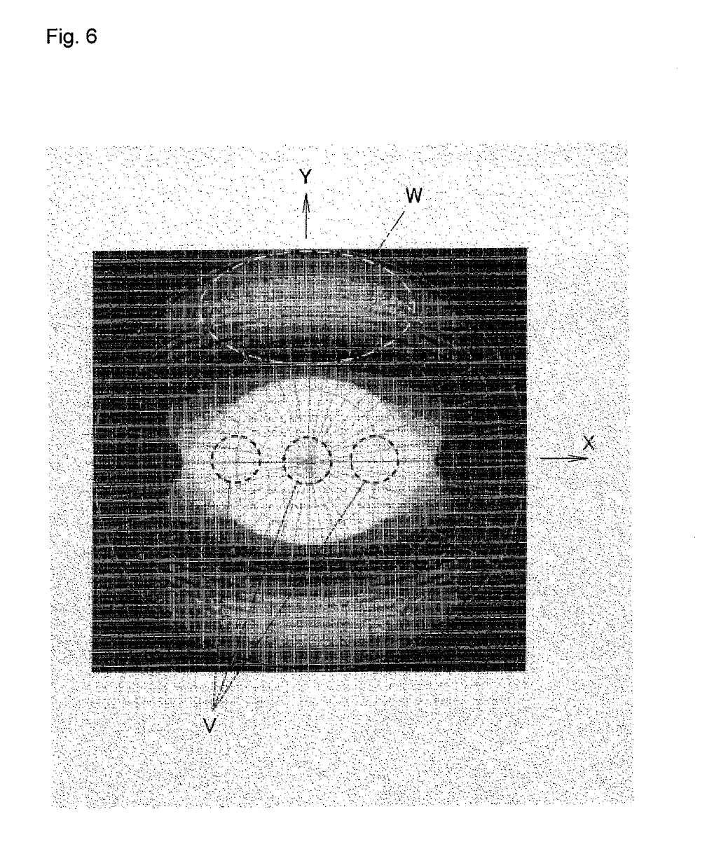

FIG. 7 is a view illustrating the directivity characteristic in the lateral direction and the directivity characteristic in the longitudinal direction, according to the first prior-art example.

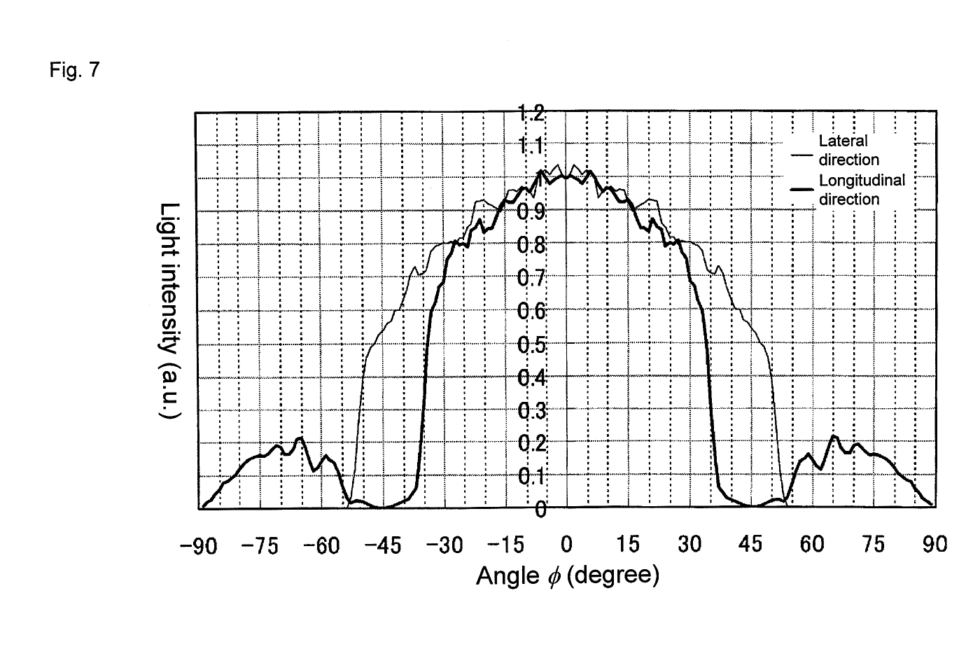

FIG. 8 is a perspective view illustrating a prism sheet in a second prior-art example.

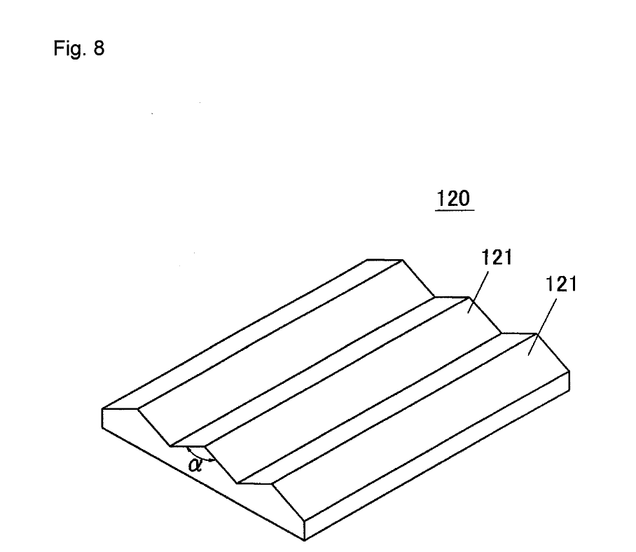

FIG. 9 is a directivity characteristic diagram illustrating the results of simulations, assuming that unit prisms have an apical angle of 95 degrees in the second prior-art example.

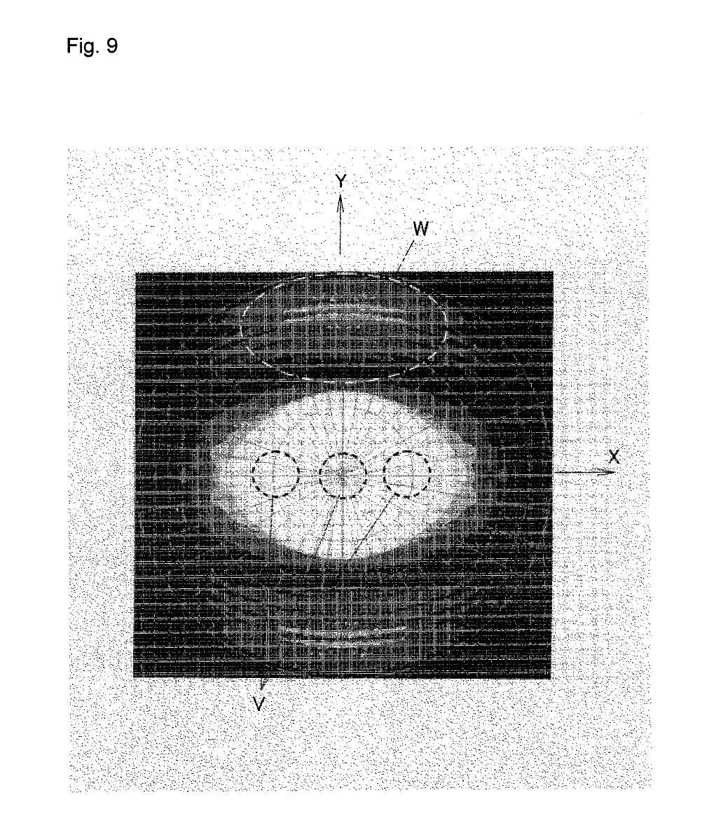

FIG. 10 is a view illustrating the directivity characteristic in the lateral direction and the directivity characteristic in the longitudinal direction, according to the results of simulations in FIG. 9.

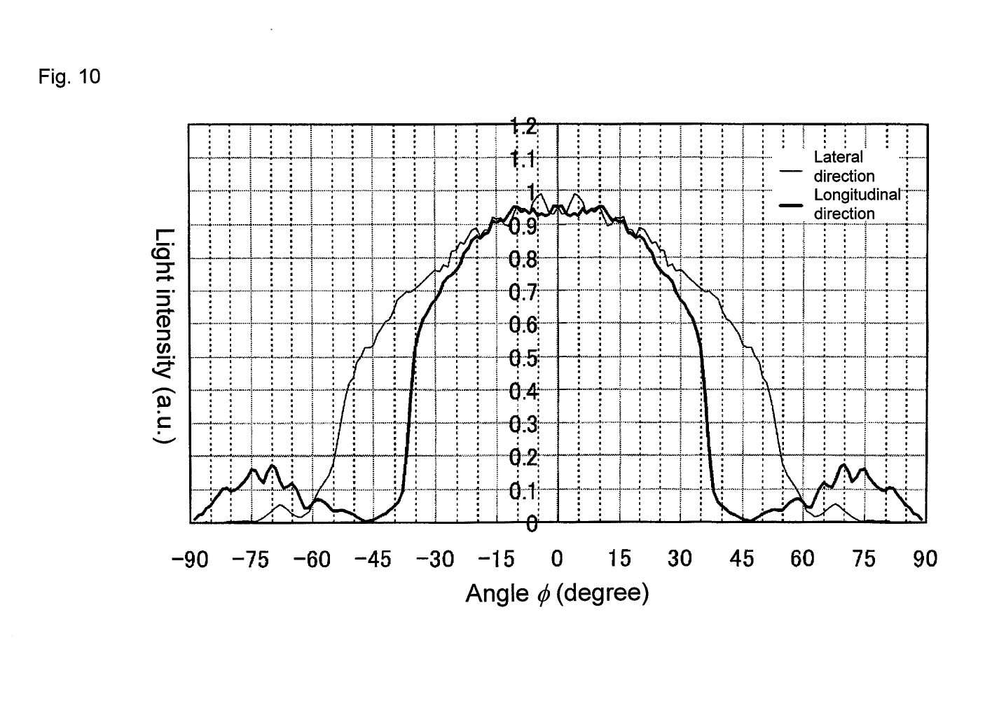

FIG. 11 is a directivity characteristic diagram illustrating the results of simulations, assuming that unit prisms have an apical angle of 110 degrees in the second prior-art example.

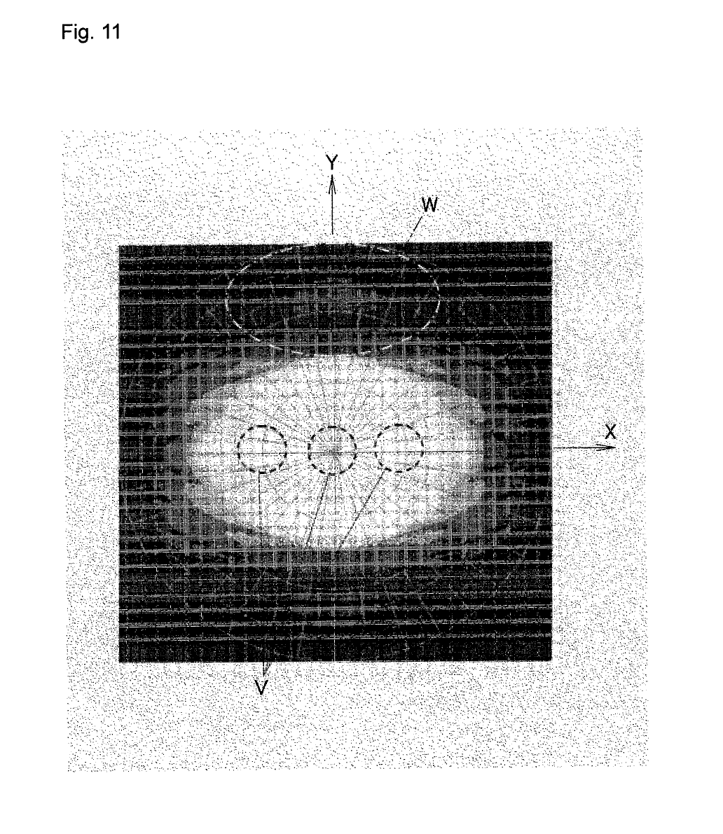

FIG. 12 is a view illustrating the directivity characteristic in the lateral direction and the directivity characteristic in the longitudinal direction, according to the results of simulations in FIG. 11.

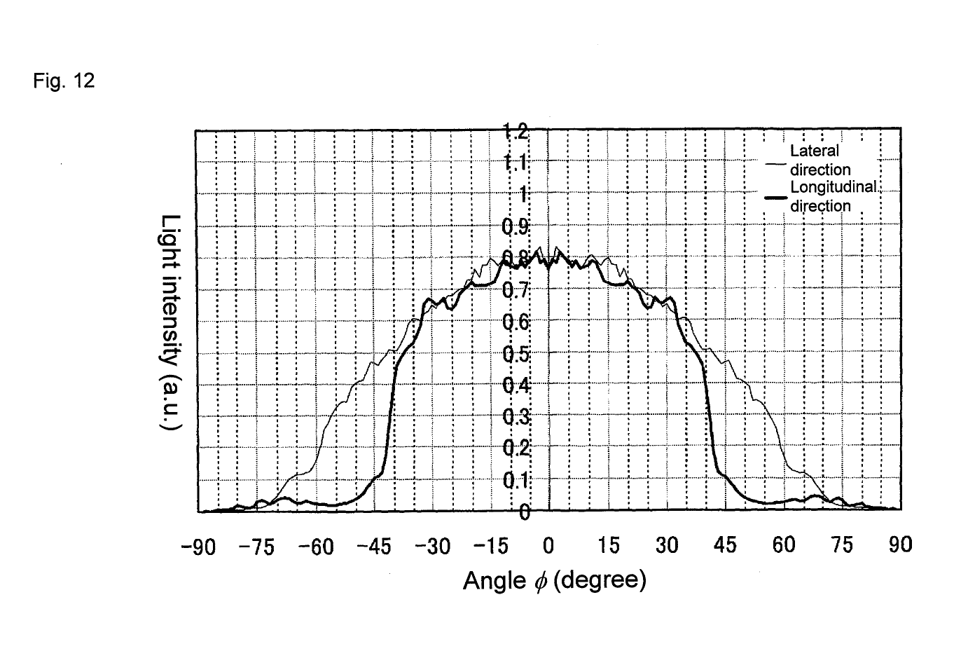

FIG. 13 is a schematic cross-sectional view of a surface light source device according to a third prior-art example.

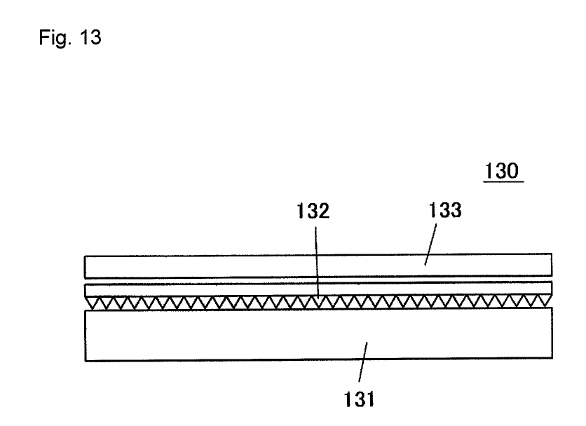

FIG. 14 is a view illustrating another model for determining directivity characteristics of a surface light source device through simulations.

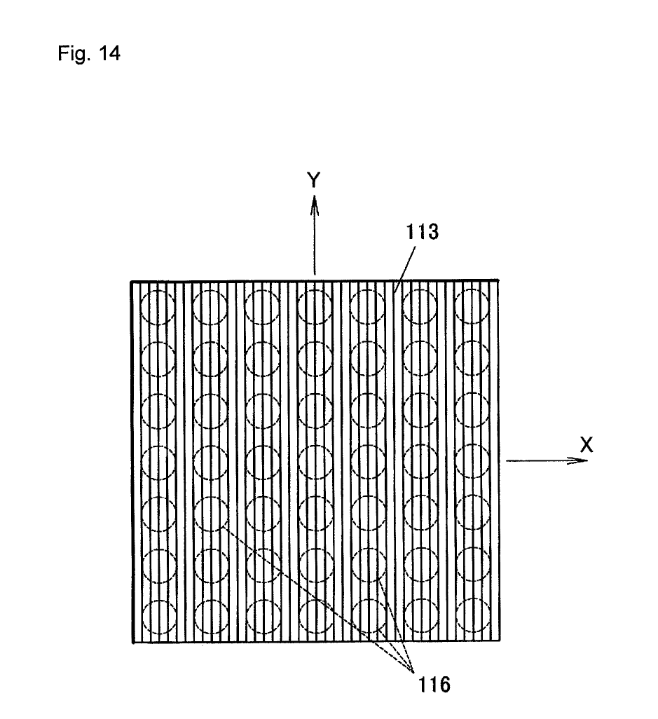

FIG. 15 is a view illustrating the results of simulations for a directivity characteristic of the third prior-art example.

FIG. 16 is a view illustrating the directivity characteristic in the lateral direction and the directivity characteristic in the longitudinal direction, according to the first prior-art example.

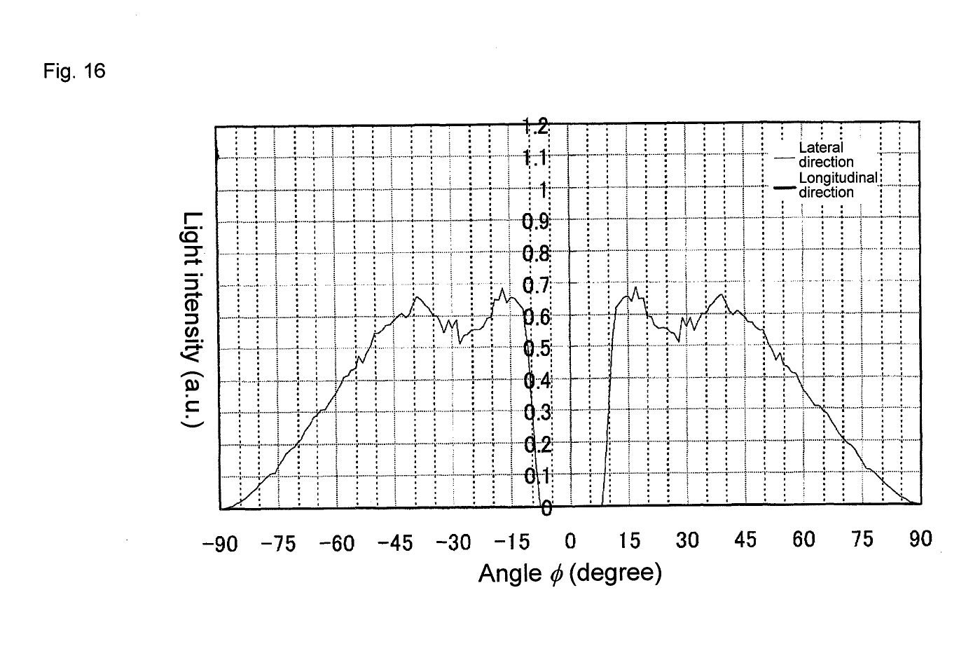

FIG. 17 is a schematic view illustrating the structure of a liquid crystal display device in a fourth prior-art example.

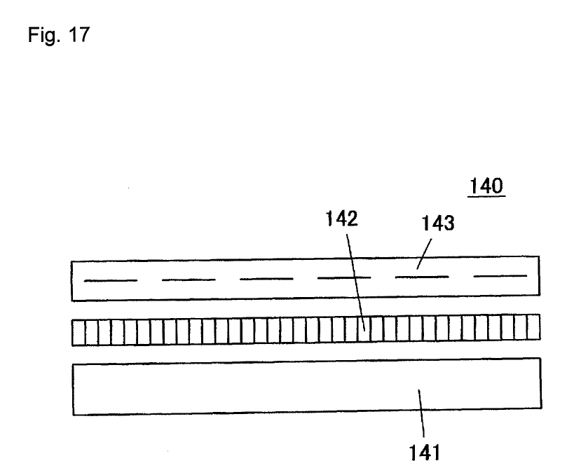

FIG. 18 is a view illustrating a directivity characteristic of the surface light source device in the liquid crystal display device in the fourth prior-art example from which the liquid crystal display panel has been eliminated, and a directivity characteristic of the surface light source device from which the louvered film has been further eliminated.

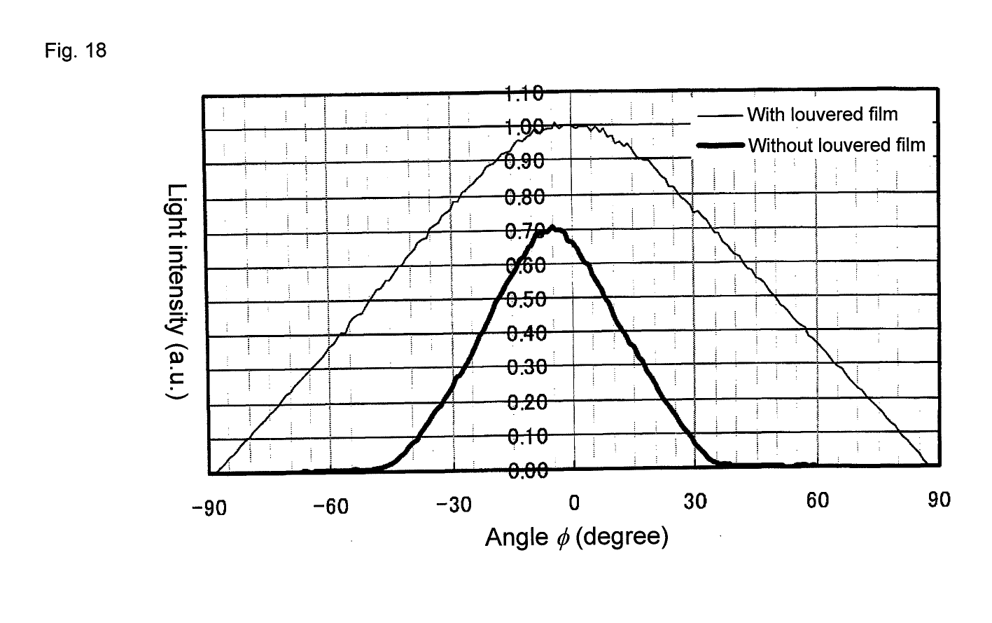

FIG. 19 is a perspective view illustrating a pair of prism sheets in a fifth prior-art example.

FIG. 20 is a view illustrating the results of simulations for a directivity characteristic of the fifth prior-art example.

FIG. 21 is a view illustrating the directivity characteristic in the lateral direction and the directivity characteristic in the longitudinal direction, according to the fifth prior-art example.

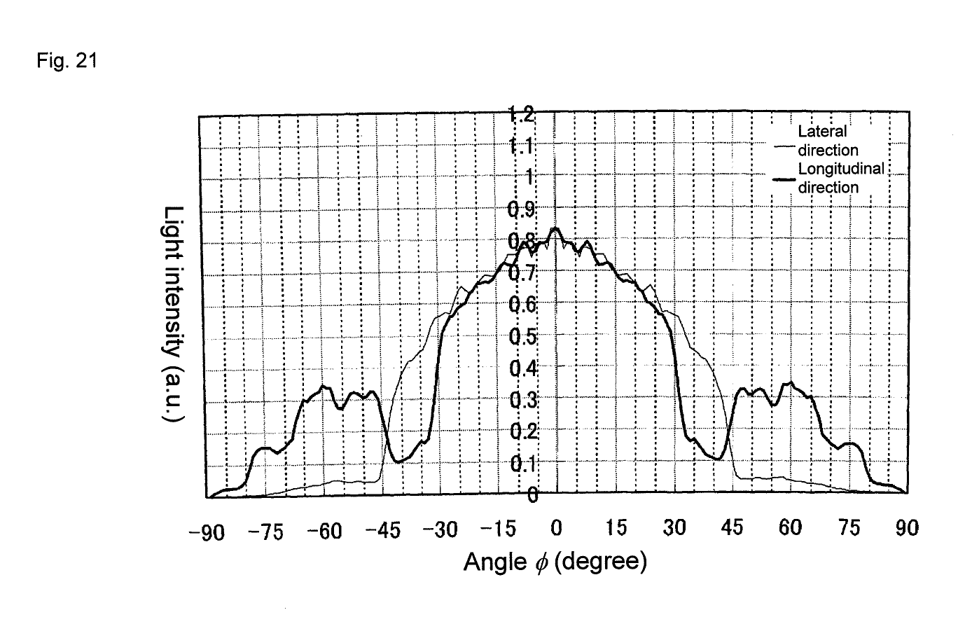

FIG. 22 is a schematic perspective view illustrating a surface light source device according to a first embodiment of the present invention.

FIG. 23 is a schematic view of a surface-shaped light source used in the surface light source device according to the first embodiment.

FIG. 24 is a schematic view of another surface-shaped light source used in the surface light source device according to the first embodiment.

FIG. 25 is a view illustrating the placement of an incident-side prism sheet and an output-side prism sheet according to the first embodiment.

FIG. 26 is a view illustrating the function of the input-side prism sheet.

FIG. 27 is a view illustrating the function of the output-side prism sheet.

FIG. 28 is a schematic view illustrating the function of the input-side prism sheet.

FIG. 29 is a schematic view illustrating the function of the output-side prism sheet.

FIG. 30 is a view illustrating a locus of light and the change of the directivity characteristic in the surface light source device according to the first embodiment.

FIG. 31 is a view illustrating the results of simulations for a directivity characteristic of the surface light source device according to the first embodiment.

FIG. 32 is a view illustrating the directivity characteristic in the lateral direction and the directivity characteristic in the longitudinal direction, in the surface light source device according to the first embodiment.

FIG. 33 illustrates the results of calculations for the relationship between the apical angle β of the unit prisms provided in the input-side prism sheet and the ratio of the amount of light emitted to an area at an angle equal to or more than −10 degrees but equal to or less than +10 degrees in the YZ plane, when Lambert light is incident to the input-side prism sheet.

FIG. 34 illustrates the results of calculations for the relationship between the apical angle γ of the unit prisms provided in the output-side prism sheet and the side-lobe intensity when Lambert light is incident to the output-side prism sheet.

FIGS. 35(a) and (b) are views illustrating a case where one of the prism sheets is rotated about an axis perpendicular to both the prism sheets for intersecting the prism longitudinal directions of the input-side prism sheet and the output-side prism sheet with each other.

FIG. 36 is a directivity characteristic diagram in a case where the prism longitudinal direction of the input-side prism sheet and the prism longitudinal direction of the output-side prism sheet are placed to form an angle of 10 degrees and, also, the prism longitudinal direction of the input-side prism sheet is made parallel with the X direction.

FIG. 37 is a view illustrating the directivity characteristic in the lateral direction and the directivity characteristic in the longitudinal direction, according to the results of simulations in FIG. 36.

FIG. 38 is a directivity characteristic diagram in a case where the prism longitudinal direction of the input-side prism sheet and the prism longitudinal direction of the output-side prism sheet are placed to form an angle of 15 degrees and, also, the prism longitudinal direction of the input-side prism sheet is made parallel with the X direction.

FIG. 39 is a view illustrating the directivity characteristic in the lateral direction and the directivity characteristic in the longitudinal direction, according to the results of simulations in FIG. 38.

FIG. 40 is a directivity characteristic diagram in a case where the prism longitudinal direction of the input-side prism sheet and the prism longitudinal direction of the output-side prism sheet are placed to form an angle of 20 degrees and, also, the prism longitudinal direction of the input-side prism sheet is made parallel with the X direction.

FIG. 41 is a view illustrating the directivity characteristic in the lateral direction and the directivity characteristic in the longitudinal direction, according to the results of simulations in FIG. 40.

FIG. 42 is a schematic cross-sectional view of a surface light source device according to a second embodiment of the present invention.

FIG. 43 is a schematic cross-sectional view illustrating a case where a diffusion sheet is placed at a different position in the surface light source device according to the second embodiment.

FIG. 44 is a schematic cross-sectional view illustrating a case where a diffusion sheet is placed at a further different position in the surface light source device according to the second embodiment.

FIG. 45 is a schematic cross-sectional view of a surface light source device according to a third embodiment of the present invention.

FIG. 46 is a perspective view of an example of the structure of a surface-shaped light source used in the surface light source device according to the third embodiment.

FIG. 47 is a schematic cross-sectional view illustrating a different structure of the surface-shaped light source according to the third embodiment.

FIG. 48 is a schematic cross-sectional view illustrating a further different structure of the surface-shaped light source according to the third embodiment.

FIG. 49 is a schematic cross-sectional view illustrating a further different structure of the surface-shaped light source according to the third embodiment.

FIG. 50 is a schematic perspective view illustrating the structure of a liquid crystal display device according to a fourth embodiment of the present invention.

### DESCRIPTION OF SYMBOLS

10, 20, 30 Surface light source device
11, 31 Surface-shaped light source
12 Input-side prism sheet
13 Output-side prism sheet
14, 39 Light emission surface
15, 16, 33, 36 Unit prism
17 Diffusion plate
18, 38 Light source
19, 37 Optical waveguide plate
21 Diffusion sheet
32, 35 Prism sheet
34 Surface-shaped light source
40 Concave portion
41 Reflection sheet
42 Diffusion sheet
43 Convex portion
50 Liquid crystal display device
51 Liquid crystal display panel
V Irradiation area
W Non-irradiation area

### DETAILED DESCRIPTION

Hereinafter, preferred embodiments of the present invention will be described, with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

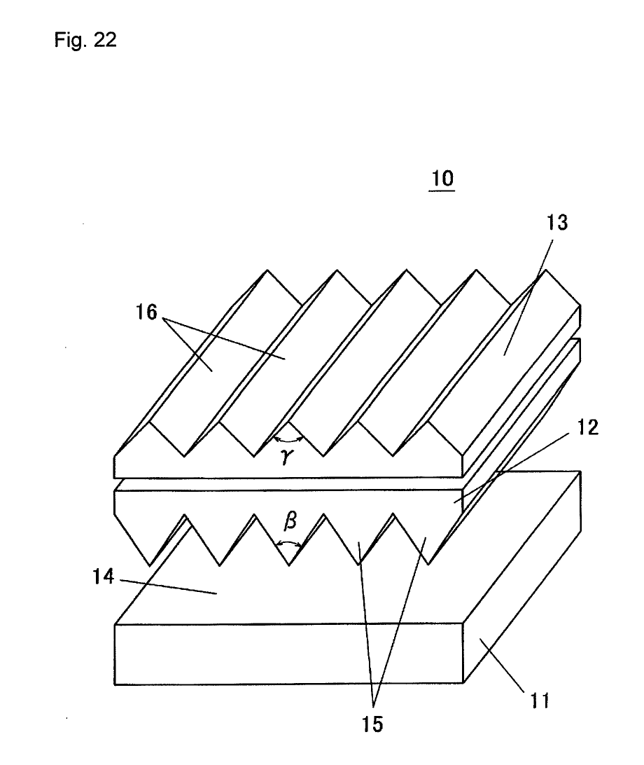

FIG. 22 is a schematic perspective view illustrating a surface light source device 10 according to a first embodiment of the present invention. The surface light source device 10 includes a surface-shaped light source 11, an input-side prism sheet 12 (a first prism sheet), and an output-side prism sheet 13 (a second prism sheet).

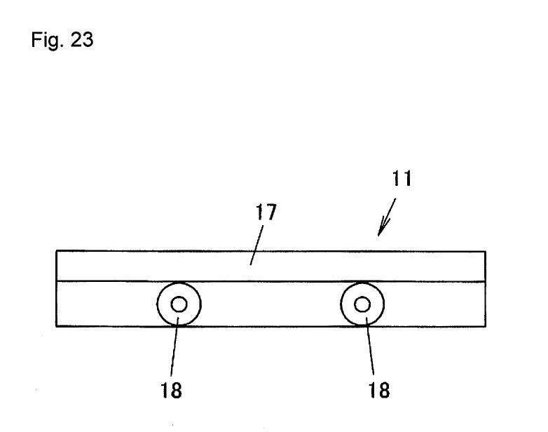

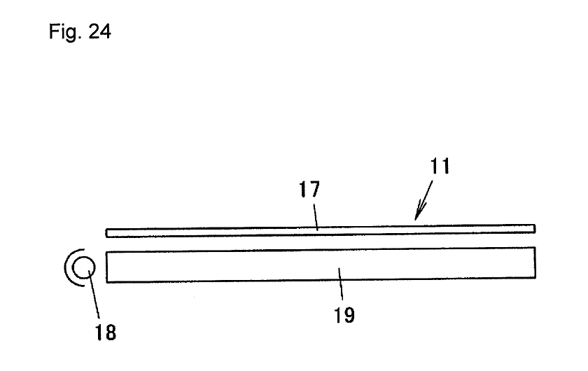

The surface-shaped light source 11 can be of any type and can have any structure, provided that it is capable of uniformly emitting light from a light emission surface 14 at its front surface. For example, the surface-shaped light source 11 can be either a surface-shaped light source of a direct-beneath type including a diffusion plate 17 and a light source 18 such as an LED or a cold-cathode tube which is placed near the back surface of the diffusion plate 17 as illustrated in FIG. 23 or a surface-shaped light source of an edge light type including an optical waveguide plate 19, a light source 18 such as an LED or a cold-cathode tube which is placed such that it is faced to a side surface of the optical waveguide plate 19, and a diffusion plate 17 overlaid on the front surface of the optical waveguide plate 19 as illustrated in FIG. 24. Further, the surface-shaped light source 11 is preferably one having such a directivity characteristic that light emitted from the light emission surface spreads entirely, namely one having such a directivity characteristic as to have no peak in a certain angular direction, and is preferably, for example, one which emits light having a Lambert-type directivity characteristic from an arbitrary position on the light emission surface.

The input-side prism sheet 12 is constituted by small unit prisms 15 with a triangular prism shape which are arranged in parallel with one another, wherein each unit prism 15 has an apical angle β which is equal to or larger than 72 degrees but equal to or smaller than 100 degrees. The output-side prism sheet 13 is constituted by small unit prisms 16 with a triangular prism shape which are arranged in parallel with one another, wherein each unit prism 16 has an apical angle γ which is equal to or larger than 100 degrees but is equal to or smaller than 125 degrees. The input-side prism sheet 12 and the output-side prism sheet 13 are formed from a transparent resin with a high refractive index, and the refractive index thereof is preferably equal to or higher than 1.55. By employing a material having a refractive index equal to or higher than 1.55, it is possible to increase the effect of condensing light passed through the prism sheets 12 and 13.

Further, it is desirable that the pitch of the arrangement of the unit prisms 15 and 16 (therefore, the width of the unit prisms 15 and 16) is equal to or more than 10 micrometers but is equal to or less than 1000 micrometers. If the arrangement pitch is larger than 1000 micrometers, the unit prisms 15 and 16 are conspicuous, and, on the other hand, if the arrangement pitch is smaller than 10 micrometers, this will induce diffraction of light or will increase the difficulty of fabricating the prism sheets 12 and 13. Namely, by making the arrangement pitch of the unit prisms 15 and 16 equal to or more than 10 micrometers but equal to or less than 1000 micrometers, it is possible to prevent the unit prisms 15 and 16 from being conspicuous and to prevent the occurrence of effects of diffraction grating and, further, it is possible to provide the advantage of ease of the fabrication of the prism sheets 12 and 13. Further, the unit prisms 15 and 16 can be formed to have a curvature with a radius of curvature of 10 micrometers or less, at their top portions, in their cross sectional areas perpendicular to the longitudinal direction. It is optically desirable that the top portion of each unit prism 15 and 16 has an angle formed by two planes intersected with each other. However, by slightly rounding these top portions, it is possible to increase the strength of the unit prisms 15 and 16 and, further, it is possible to provide some curvature in fabrication. On the other hand, if the curvature in the unit prisms 15 and 16 is excessive, this will induce large changes in the directivity characteristic of light passed through the prism sheets 12 and 13. Therefore, it is preferable that the radius of curvature is equal to or less than 10 micrometers.

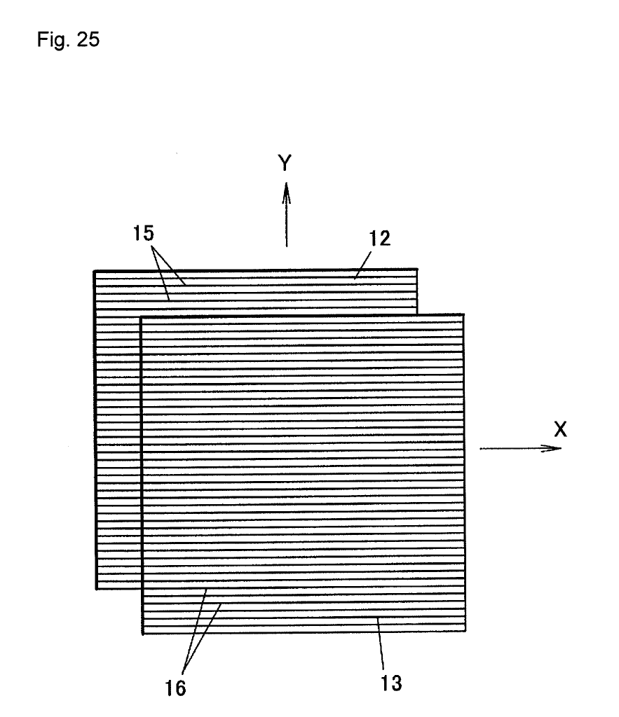

The input-side prism sheet 12 and the output-side prism sheet 13 are placed, such that their surfaces opposite from their surfaces provided with the unit prisms 15 and 16 (hereinafter, referred to as prism-formation surfaces) are faced to each other. Further, as illustrated in FIG. 25, the input-side prism sheet 12 and the output-side prism sheet 13 are placed, such that the prism longitudinal direction of the input-side prism sheet 12 and the prism longitudinal direction of the output-side prism sheet 13 are parallel with each other. The surfaces of the input-side prism sheet 12 and the output-side prism sheet 13 which are opposite from their prism-formation surfaces may either be flattened or be provided with convexities and concavities which are finer than the unit prisms 15 and 16. By flattening their surfaces opposite from the prism formation surfaces, it is possible to prevent diffusion of light passed through the prism sheets 12 and 13, thereby reducing light emitted in unnecessary directions. Further, by forming fine convexities and concavities on their surfaces opposite from the prism-formation surfaces, it is possible to prevent the prism sheets 12 and 13 from being optically coupled to each other, when they are laminated.

The input-side prism sheet 12 is placed such that its prism-formation surface is faced to the light emission surface 14 in the surface-shaped light source 11. The output-side prism sheet 13 is placed in the opposite side from the surface-shaped light source 11 with the input-side prism sheet 12 sandwiched therebetween, and its prism-formation surface is oriented toward the opposite side from the surface-shaped light source 11.

These prism sheets 12 and 13 are formed as follows, through a 2P method (Photo Polymerization method) using a UV curing resin. In a molding die, there is formed a reverse pattern for the prism-formation surfaces of the prism sheets 12 and 13 and, at first, a UV curing resin of a liquid type or a fluid type is dropped into this die. Then, a transparent resin sheet made of a polycarbonate resin, a polyolefin, a PET, an acrylic resin or the like is placed on the UV curing resin and, then, the UV curing resin is pressed from thereabove using a transparent plate, so that the UV curing resin is spread such that it is interposed between the die and the transparent resin sheet. At this state, an UV ray is applied to the UV curing resin, through the transparent plate and the transparent sheet, to cure the UV curing resin. Thereafter, the molded article is disengaged from the die, which results in formation of the unit prisms 15 and 16 from the UV curing resin on the surface of the transparent resin sheet, thereby providing the prism sheets 12 and 13. Further, desirably, the transparent resin sheet has a refractive index equal to that of the cured UV curing resin.

By forming the prism sheets 12 and 13 through transfer of the patterns of the die, it is possible to form the fine unit prisms 15 and 16 with excellent accuracy and, also, it is possible to perform mass production of prism sheets 12 and 13 with a low cost. Further, since the UV curing resin has high hardness, it is possible to fabricate the prism sheets 12 and 13 with high strength.

In cases where the surface light source device 10 is incorporated in an in-car monitor and the like, as illustrated in FIG. 25, the surface light source device 10 is incorporated therein, such that the prism longitudinal lengths of the prism sheets 12 and 13 are oriented in the lateral direction (an X direction), and the direction of the prism arrangement is oriented in the longitudinal direction (a Y direction), when it is used. In this case, the lateral direction is a horizontal direction as described with respect to the prior-art example, while the longitudinal direction is an upward/downward direction or an oblique upward/downward direction which is inclined forwardly or rearwardly.

[Effects and Functions]

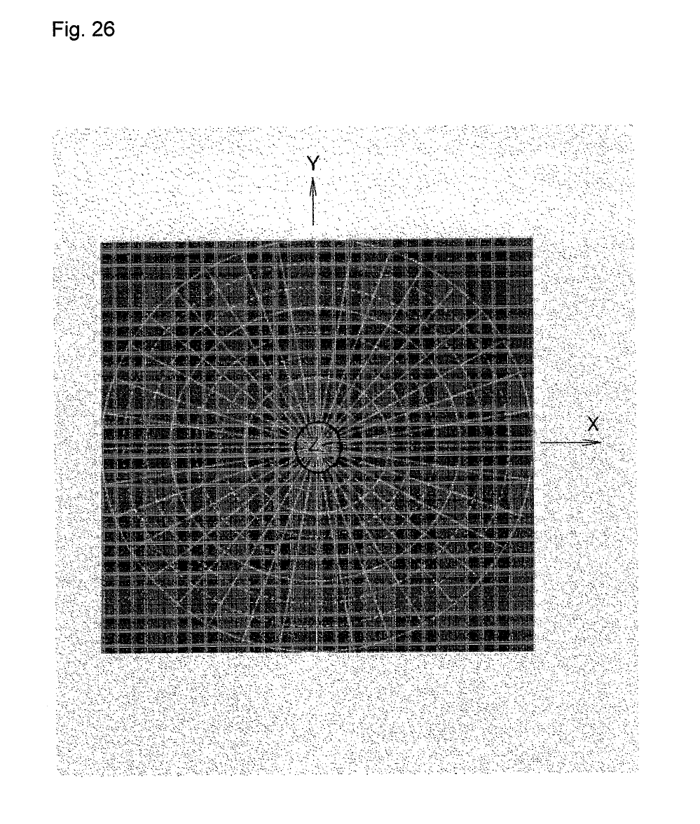

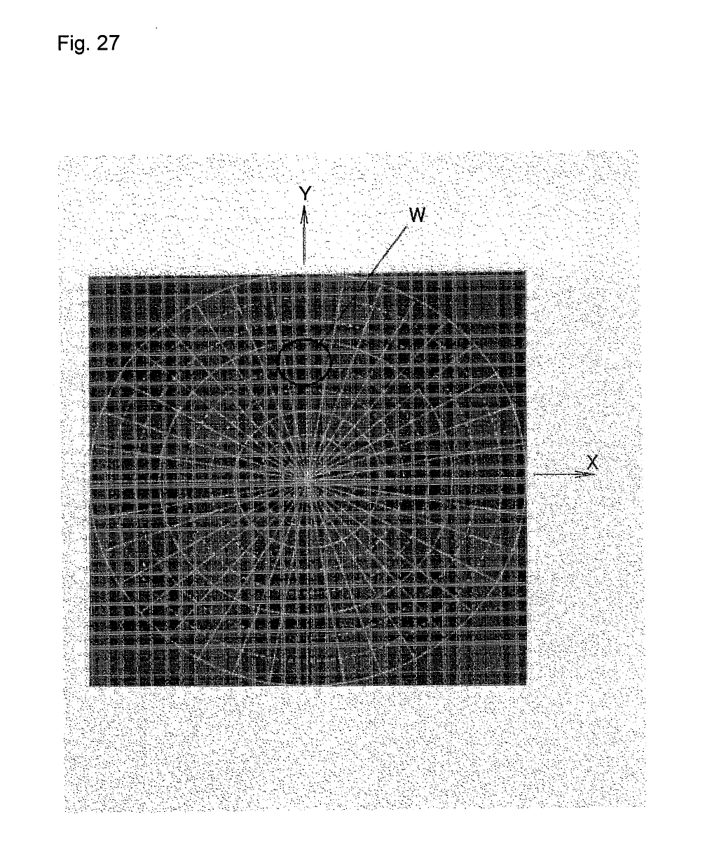

Next, the policy of the design of the surface light source device 10 will be described and, thereafter, effects and functions thereof will be described. The input-side prism sheet 12 mainly has the function of preventing light emission toward an area in the Z direction which is enclosed by a solid line in FIG. 26. Further, the output-side prism sheet 13 has the function of preventing the light incident thereto from the input-side prism sheet 12 from being emitted toward a non-irradiation area W enclosed by a solid line in FIG. 27. In other words, the input-side prism sheet 12 is provided with such a directivity characteristic as to prevent the light passed through the input-side prism sheet 12 from being emitted in the Z direction. Further, the output-side prism sheet 13 is provided with such a directivity characteristic that, if light is incident thereto from the input-side prism 12 in parallel with the Z direction, the light is emitted toward the non-irradiation area W. Further, the surface light source device 10 has a directivity characteristic symmetrical with respect to a YZ plane and a ZX plane and, therefore, only the side of positive inclinations φ will be described, hereinafter, but the description also applies to the negative side in a manner that the positive side and the negative side are symmetrical, unless otherwise specified.

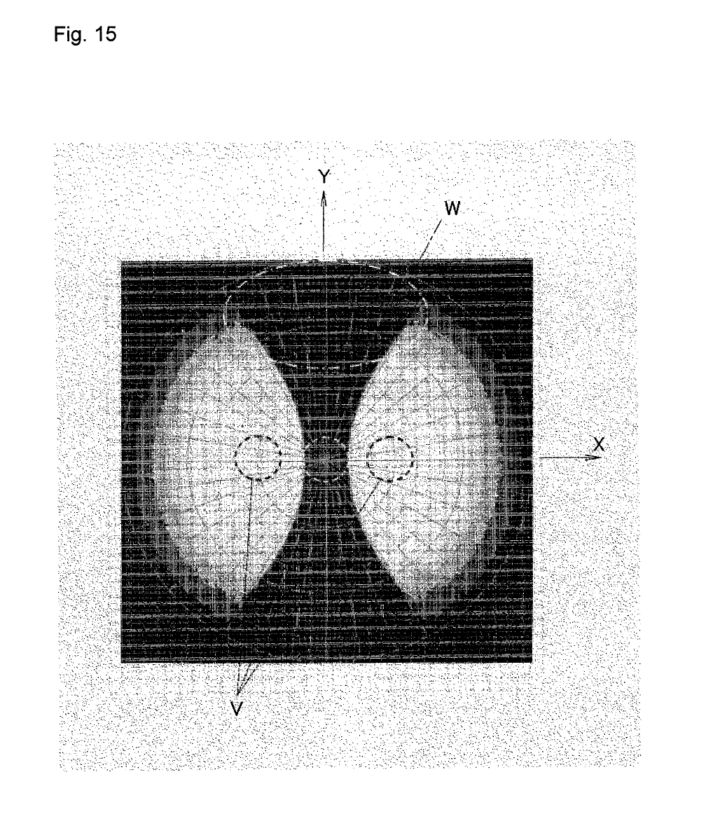

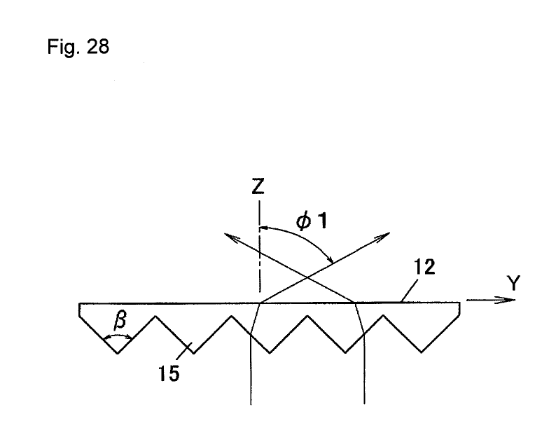

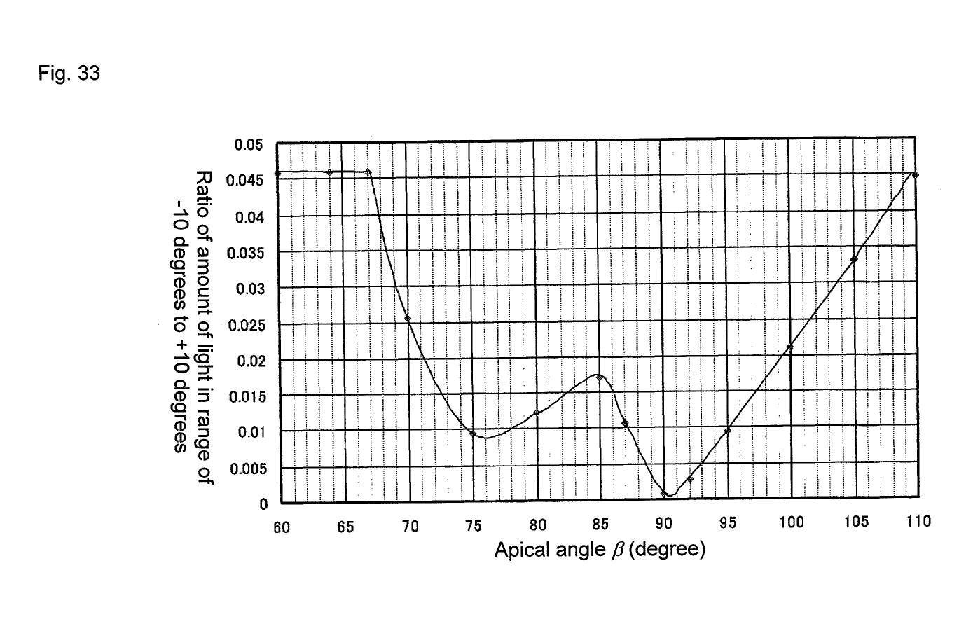

In the input-side prism sheet 12, the unit prisms 15 are oriented in the direction of the light incidence and, as illustrated in FIG. 28, light incident to the input-side prism sheet 12 perpendicularly thereto is refracted by the unit prisms 15 and, thus, is emitted in a direction inclined with respect to the vertical direction in the ZY plane. For example, assuming that the unit prisms 15 have an apical angle β of 90 degrees and a refractive index of 1.59, as illustrated in FIG. 28, light which is perpendicularly incident to the input-side prism 12 is emitted in a direction inclined by φ1=30 degrees toward the longitudinal direction (the Y direction) and, thus, is not emitted in the vertical direction (the Z direction) (in actual, Lambert light is incident thereto and, therefore, according to FIG. 33 which will be described later, the light is not emitted in the range of −10 degrees to +10 degrees, as well as in the vertical direction). Further, in the case where the unit prisms 15 have an apical angle β of 90 degrees, this case is equal to a case where the prism sheet 132 in the third prior-art example is rotated by 90 degrees about the Z direction and, therefore, when Lambert light is incident to the input-side prism sheet 12, the directivity characteristic diagram is the same as the directivity characteristic diagram in FIG. 15 which is rotated by 90 degrees and, accordingly, it can be understood that the light is not emitted in the Z direction and is emitted by being branched in the Y direction.

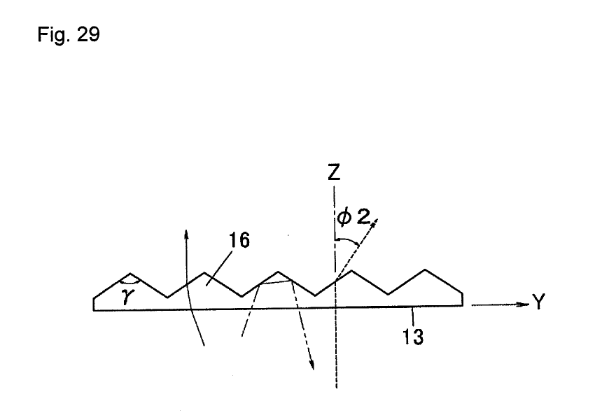

Further, in the output-side prism sheet 13, the unit prisms 16 are oriented in the direction of light emission, and if light is incident to the output-side prism sheet 13 perpendicularly thereto, the light is refracted by the unit prisms 16 and, thus, is emitted in a direction inclined with respect to the vertical direction in the ZY plane, as illustrated by a broken-line arrow in FIG. 29. The light passed through the input-side prism sheet 12 is hardly emitted in the vertical direction and, therefore, by orienting the direction of emission of perpendicularly-incident light toward the non-irradiation area W, it is possible to prevent the non-irradiation area W from lighting brightly. For example, in the case where the unit prisms 16 have an apical angle γ of 112 degrees and a refractive index of 1.59, as illustrated by the broken-line arrow in FIG. 29, light incident to the output-side prism sheet 13 perpendicularly thereto is emitted to an area having an inclination φ2 of about 30 degrees toward the longitudinal direction (the Y direction). Further, if light is incident to the output-side prism sheet 13 with an incidence angle in the range of −8 degrees to +8 degrees, the light is emitted in a direction at an angle φ in the range of −56 degrees to −16 degrees and in the range of 16 degrees to 56 degrees, due to refraction. Accordingly, provided that the light passed through the input-side prism sheet 12 is hardly emitted in the vertical direction, the light passed through the output-side prism sheet 13 is hardly emitted to the area having an inclination of about 30 degrees with respect to the Z direction. Further, provided that light is not emitted from the input-side prism sheet 12 in the range of 8 degrees or less, the light passed through the output-side prism sheet 13 is hardly emitted to an area having an inclination in the range of 16 degrees to 56 degrees with respect to the Z direction, thereby resulting in darkness. Furthermore, in directions having inclinations equal to or more than about 60 degrees with respect to the Z direction, light is totally reflected by inclined surfaces of the unit prisms 16 and, then, is totally reflected by the other inclined surfaces, which prevents light emission in these directions, as illustrated by a two-dot-chain-line arrow in FIG. 29. This results in a small amount of side-lobe light, thereby preventing the non-irradiation area W from being bright.

On the other hand, as illustrated by a narrow-solid-line arrow in FIG. 29, light incident to the output-side prism sheet 13 with an incidence angle of about 22 degrees is emitted from the output-side prism sheet 13 in a direction substantially perpendicular thereto. Accordingly, the light passed through the input-side prism sheet 12 is not emitted in the vertical direction and in the ZX plane, but the light is emitted in the vertical direction and to the irradiation area V near the ZX plane after passing through the output-side prism sheet 13.

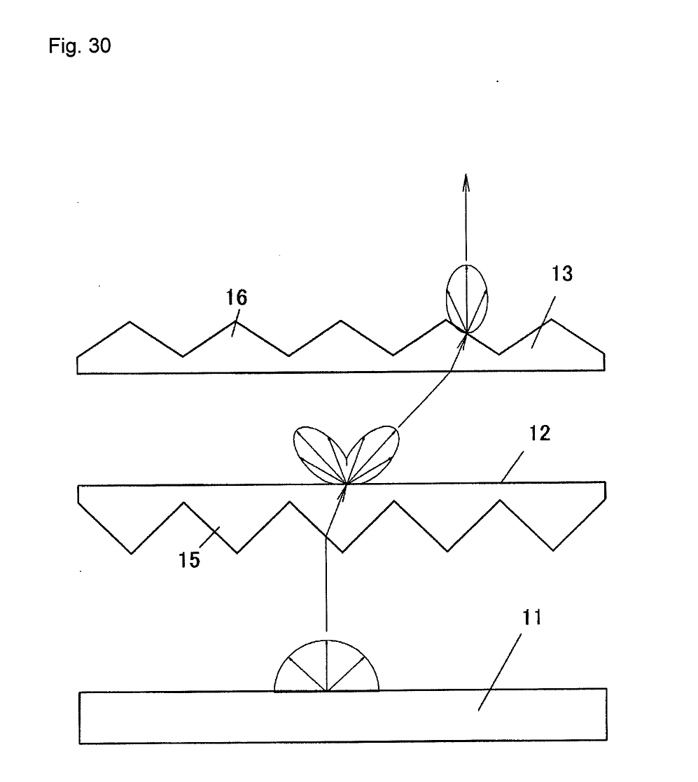

FIG. 30 is a view comprehensively illustrating the function of the input-side prism sheet 12 and the function of the output-side prism sheet 13 as described above. When viewed in the longitudinal direction (in the YZ plane), Lambert light emitted from the surface-shaped light source 11 is passed through the input-side prism sheet 12 to be changed to light having such a directivity characteristic as to have darkness in the vertical direction and have brightness in oblique directions and, further, the light passes through the output-side prism sheet 13 to be changed to light having such a directivity characteristic as to have brightness only in the vertical direction. Further, when viewed in the lateral direction (in the ZX plane), the Lambert light emitted from the surface-shaped light source 11 is not influenced in its directivity characteristic by being passed through the input-side prism sheet 12 and the output-side prism sheet 13 and, therefore, is spread laterally even after being passed through the prisms sheets 12 and 13. Particularly, by employing a surface-shaped light source of a type having an entirely-spread directivity characteristic as the surface-shaped light source 11, it is possible to widen the directivity characteristic of emitted light in the prism longitudinal direction, thereby spreading light over a wide range in the lateral direction.

As a result, due to the synergistic effects of both the prism sheets 12 and 13, the surface light source device 10 is capable of emitting light having such a directivity characteristic as to have high brightness in the irradiation areas V spread widely in the lateral direction and have darkness in the non-irradiation area W.

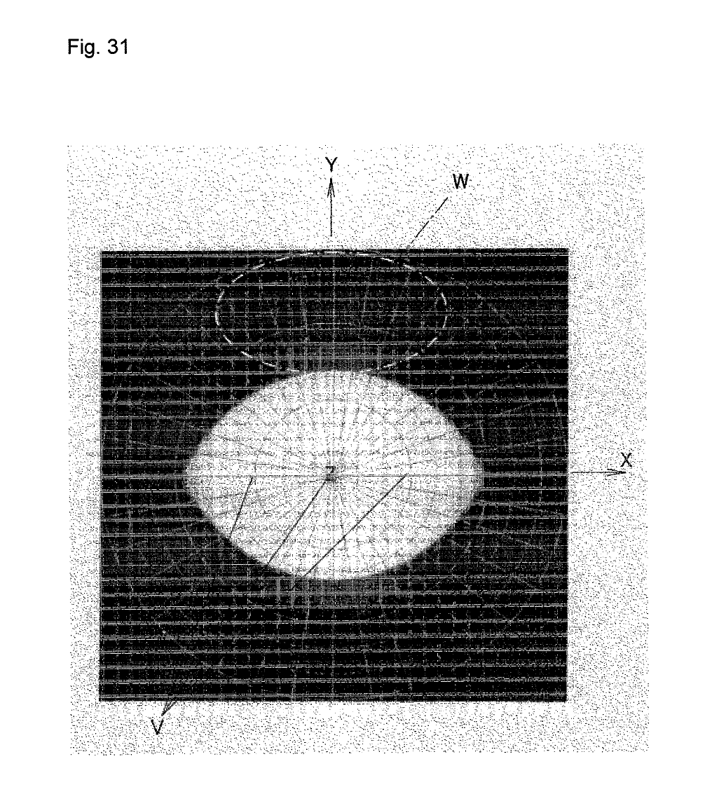

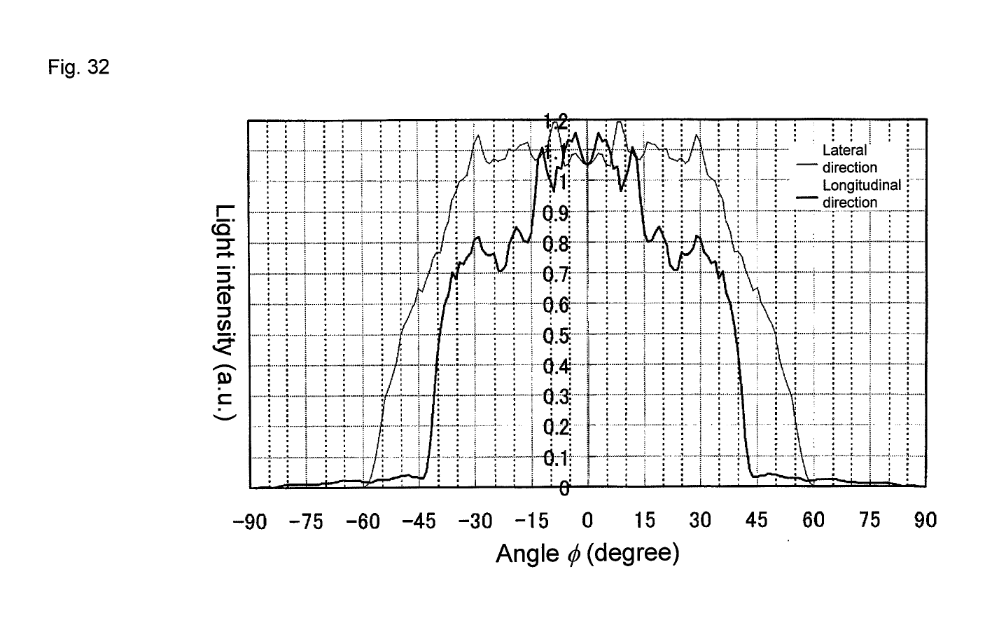

FIG. 31 is a directivity characteristic diagram illustrating the result of determination for a directivity characteristic of light passed through the pair of the prism sheets 12 and 13, under the same simulation conditions as those in the first prior-art example. Further, FIG. 32 is a view illustrating the directivity characteristic (a narrow line) in the lateral direction (in the ZX plane) and the directivity characteristic (a thick line) in the longitudinal direction (in the YZ plane), in this case. In this case, it is assumed that the unit prisms 15 have an apical angle of 90 degrees and a refractive index of 1.59, while the unit prisms 16 have an apical angle γ of 112 degrees and a refractive index of 1.59. As illustrated in FIG. 32, with the surface light source device 10 according to the first embodiment, in the longitudinal direction (in the YZ plane), the light intensity is substantially zero when the inclination φ is equal to or more than 44 degrees and when it is equal to or less than −44 degrees, and the non-irradiation area W is dark as illustrated in FIG. 31. Accordingly, even when it is used in an in-car monitor and the like, for example, it is possible to prevent light emitted to the non-irradiation area W from being reflected on the front glass to obstruct the driving. Further, in the longitudinal direction, light is gathered in the narrow range of −44 degrees to 44 degrees and, further, in the direction of 0 degrees (the Z direction), the light intensity is larger by 10% than that in the first prior-art example, thereby increasing the brightness in the irradiation area V. Further, there is a wide directivity in the lateral direction, and substantially the same brightness as that in the direction of 0 degree is maintained in the range of −30 degrees to 30 degrees, which can make the irradiation area V uniformly bright.

Next, there will be described the ranges of the apical angle β of the unit prisms 15 and the apical angle γ of the unit prisms 16. There is substantially no light emitted in directions at about 60 degrees or more, out of the light passed through the output-side prism 13, as illustrated by the two-dot chain line in FIG. 29. However, in this state, there is still a wide directivity in the longitudinal direction, which makes the non-irradiation area W bright. Therefore, it is desired to prevent the light passed through the output-side prism sheet 13 from scattering in directions at about 10 degrees to about 60 degrees with respect to the vertical direction. Simulations or calculations have revealed that a major part of light scattered in directions at about 10 degrees to about 60 degrees after emitting from the output-side prism sheet 13 is constituted by light incident to the output-side prism sheet 13 at an incidence angle of 10 degrees or less. Accordingly, in order to attain the targeted characteristic, it is necessary to prevent light having an incidence angle of about 10 degrees or less from entering the output-side prism sheet 13. In order to attain this, it is necessary to prevent light emission in directions at about 10 degrees or less from the input-side prism sheet 12, as the light illustrated by the broken line in FIG. 29.

FIG. 33 illustrates the results of calculations for the relationship between the apical angle β of the unit prisms 15 (with a refractive index of 1.59) provided in the input-side prism sheet 12 and the ratio of the amount of light emitted to an area at an angle equal to or more than −10 degrees but equal to or less than +10 degrees (in the range of −10 degrees to +10 degrees) in the YZ plane, when Lambert light is incident to the input-side prism sheet 12. Referring to FIG. 33, when the apical angle β is about 90 degrees, the ratio of the amount of light emitted at angles equal to or more than −10 degrees but equal to or less than +10 degrees is substantially zero and, in practice, if this ratio is equal to or less than 0.02 (2%), this is acceptable. Accordingly, with reference to FIG. 33, it is preferable that the apical angle β of the unit prisms 15 is equal to or more than 72 degrees but equal to or less than 100 degrees. If the apical angle β is smaller than 72 degrees or larger than 100 degrees, this will increase the amount of light emitted to the non-irradiation area W even if the light is controlled by the output-side prism sheet 13, which may result in reflection thereof on the front glass. Further, if the ratio of the amount of light emitted at angles equal to or more than −10 degrees but equal to or less than +10 degrees is equal to or less than 0.01 (1%), it is possible to provide more desirable characteristics. Therefore, it is desirable to make the apical angle β of the unit prisms 15 equal to or more than 87 degrees but equal to or less than 95 degrees.

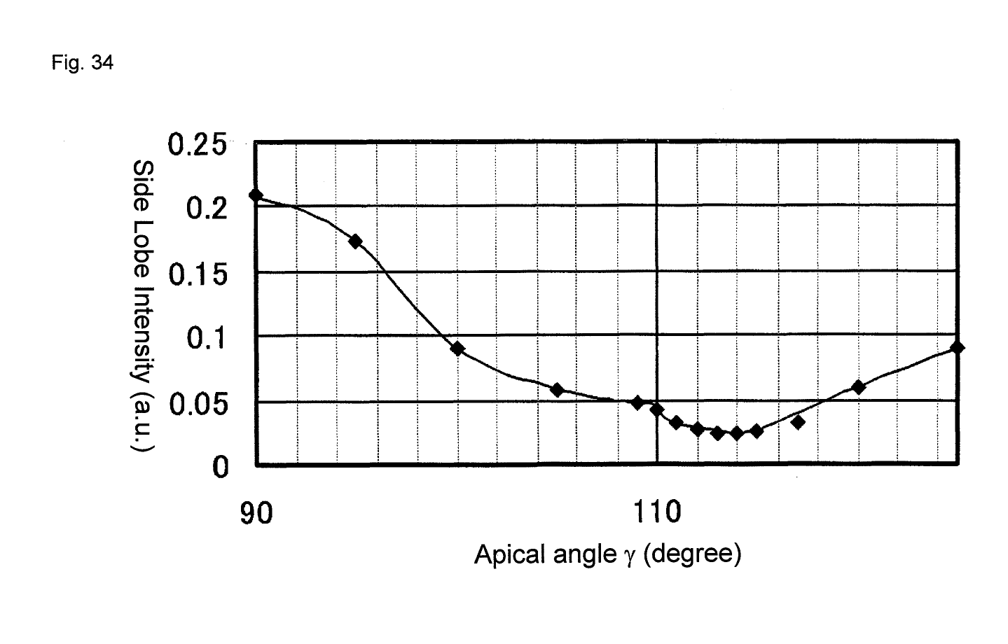

FIG. 34 illustrates the results of calculations for the relationship between the apical angle γ of the unit prisms 16 (with a refractive index of 1.59) provided in the output-side prism sheet 13 and the side-lobe intensity when Lambert light is incident to the output-side prism sheet 13. In this case, the side-lobe intensity refers to a maximum value of the light intensity of emitted light in the range of φ>60 degrees in the YZ plane. When the apical angle γ is 112 degrees, the side-lobe intensity becomes smallest. It is desirable that the side-lobe intensity is equal to or less than 0.1 (a.u.) (the light intensity in the Z direction is larger than 1 (a.u.) as illustrated in FIG. 32), with reference to FIG. 34, the apical angle γ is preferably equal to or more than 100 degrees but equal to or less than 125 degrees. More preferably, it is necessary to set the side-lobe intensity to 0.05 (a.u.) and, therefore, it is necessary to set the apical angle γ to equal to or more than 107 degrees but equal to or less than 120 degrees. Further, the luminance of the irradiation area V decreases with increasing apical angle γ and, therefore, a most preferable value of the apical angle γ which minimizes the side lobe intensity while hardly reducing the luminance of the irradiation area V is about 112 degrees.

As described above, with the surface light source device 10 according to the first embodiment, it is possible to largely reduce side-lobe light to make the non-irradiation area W dark, while providing, in the longitudinal direction, a narrow directivity characteristic capable of gathering light in the vertical direction, thereby preventing reduction of the luminance of the irradiation area V. Further, light is not gathered in the lateral direction parallel with the prism longitudinal direction of the prism sheets 12 and 13, which can maintain a wide directivity characteristic, thereby making the irradiation area V bright over a wide range. Accordingly, when the surface light source device 10 is incorporated in an in-car monitor in a car navigation system, and the in-car monitor is installed between the driving seat and the passenger seat, it is possible to enable viewing bright images at the driving seat, the passenger seat and in front thereof and, further, it is possible to prevent reflection thereof on the front glass. Furthermore, since it is constituted by the two prism sheets 12 and 13, it is possible to reduce the cost in comparison with cases of employing louvered films.

### Comparison with the Fifth Prior-Art Example

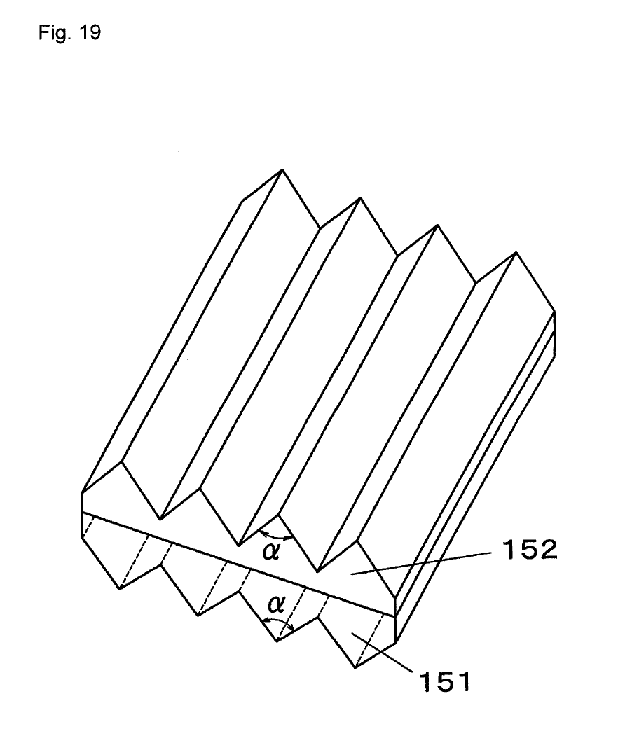

The surface light source device 10 is similar, at glance, to the prism sheets 151 and 152 (FIG. 19) which are used in the fifth prior-art example and, therefore, the difference therebetween will be described in brief. In the fifth prior-art example, the apical angle α of the prisms is set to α<2*θc (θc: the critical angle of the material). The upper limit value of the apical angle α is changed with the refractive index. It is assumed that the prism material is an acrylic or polycarbonate which are generally used.

In the case of acrylic, the refractive index is 1.49, and the following inequality holds.

α<84.3

In the case of polycarbonate, the refractive index is 1.59 and, therefore, the following inequality holds.

α<77.9

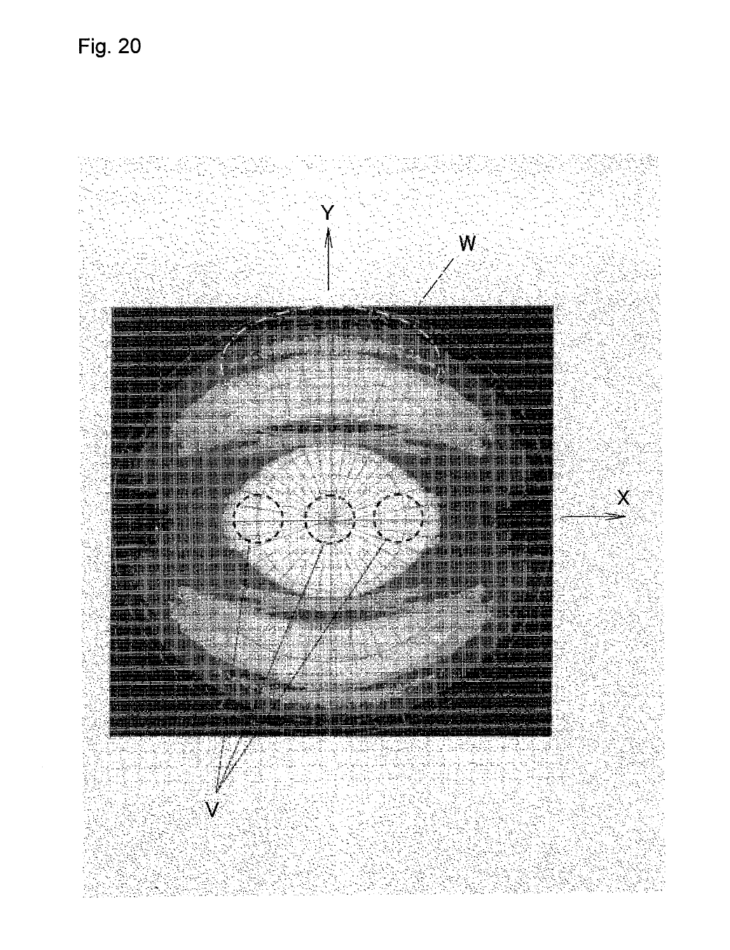

Accordingly, the apical angle α of the prisms is an angle smaller than 90 degrees, in both the prism sheets 151 and 152. Further, in the fifth prior-art example, the apical angle of the prism sheet 151 and the apical angle of the prism sheet 152 are equal to each other. Due to the existence of this constraint, in the firth prior-art example, it is impossible to offer the same effects and functions as those achievable by one or more embodiments of the present invention, and the light intensity in the non-irradiation W is significantly larger, as illustrated in FIG. 20.

### The Inclinations of the Prism Sheets with Respect to Each Other in the First Embodiment

In the surface light source device 10, when the prism longitudinal direction of the input-side prism sheet 12 and the prism longitudinal direction of the output-side prism sheet 13 are parallel with each other, it is possible to maximize the spread of emitted light in the lateral direction. Accordingly, it is desirable that the prism longitudinal directions of both the prism sheets 12 and 13 are parallel with each other, as in FIG. 25.

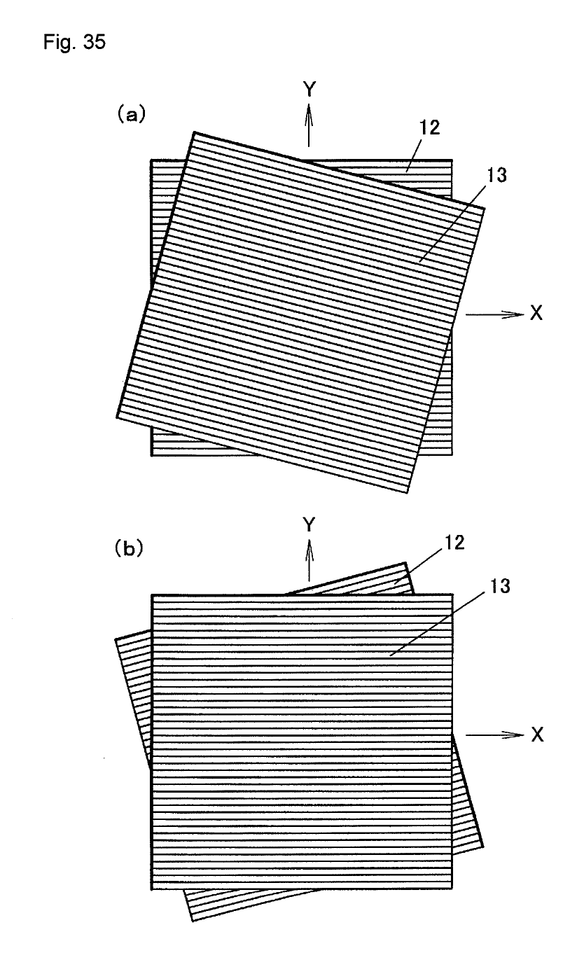

However, as illustrated in FIG. 35(a) and (b), when one of the prism sheets 12, 13 is rotated about an axis perpendicular to both the prism sheets 12 and 13 for inclining the prism longitudinal direction of the input-side prism sheet 12 and the prism longitudinal direction of the output-side prism sheet 13 with respect to each other, it is possible to offer an effect of suppressing moire fringes, when they are employed in a liquid crystal display device. On the other hand, if their prism longitudinal directions forms an angle larger than 15 degrees when both the prism sheets 12 and 13 are viewed in the direction perpendicular thereto, this may prevent the surface light source device 10 from having a left-right-symmetrical directivity characteristic in the lateral direction or from having an upper-lower-symmetrical directivity characteristic in the longitudinal direction, which may increase or decrease the light intensity depending on the angle of view, thereby degrading the quality of the surface light source device. Accordingly, in the case where the prism sheets 12 and 13 are inclined with respect to each other for the sake of more prevention and the like, it is desirable to set the angle formed between their prism longitudinal directions to be equal to or less than 15 degrees.

Further, in cases of employing prism sheets 12 and 13 having prism longitudinal directions which are not parallel with each other, it is preferable that the prism longitudinal direction of any one of the prism sheets 12 and 13 is parallel with the X direction. Also, it is possible to incline the prism longitudinal direction of the input-side prism sheet 12 and the prism longitudinal direction of the output-side prism sheet 13 in opposite directions with the X direction sandwiched therebetween.

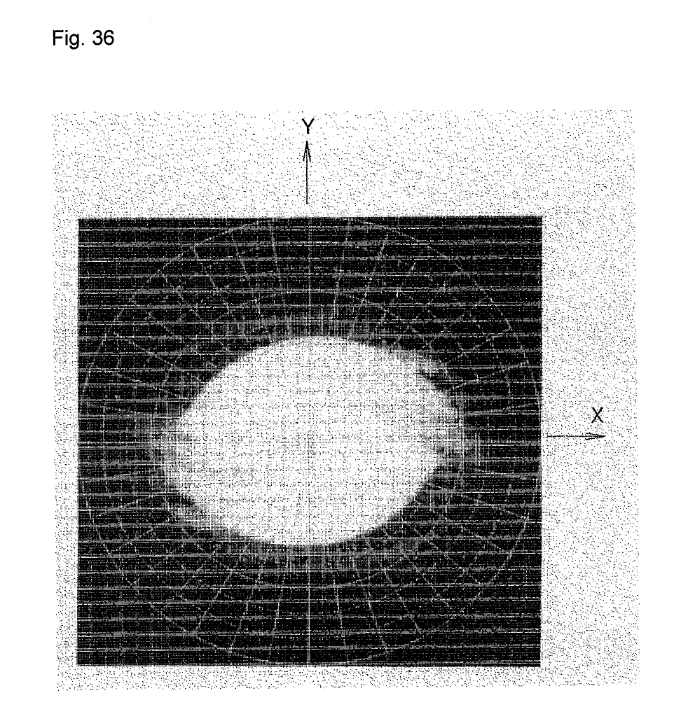

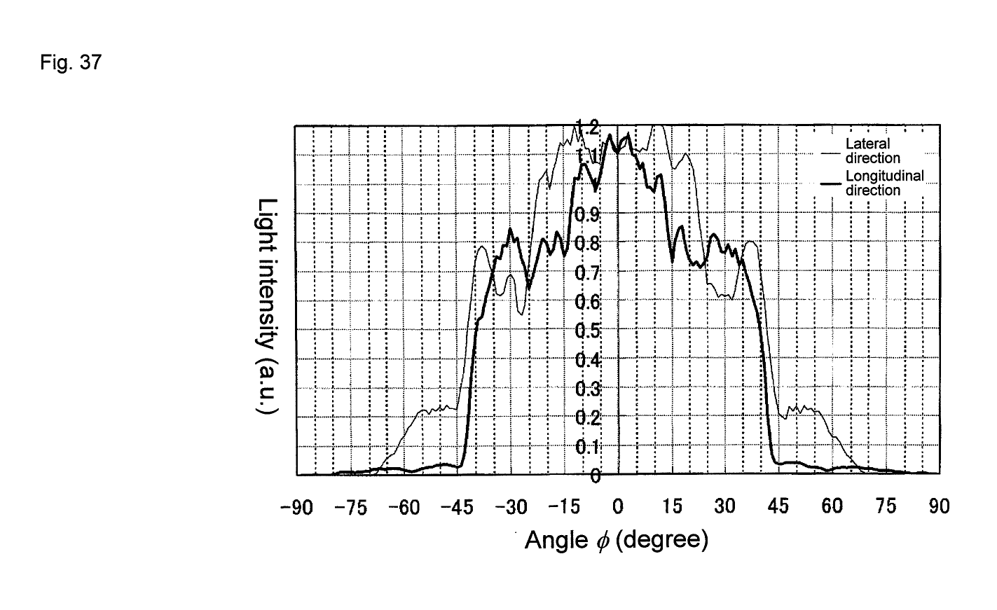

Next, there will be described the reason why the angle formed between the prism longitudinal directions should be equal to or less than 15 degrees. FIG. 36 is a directivity characteristic diagram in a case where the prism longitudinal direction of the input-side prism sheet 12 and the prism longitudinal direction of the output-side prism sheet 13 are placed to form an angle of 10 degrees and, also, the prism longitudinal direction of the input-side prism sheet 12 is made parallel with the X direction. Further, FIG. 37 is a view illustrating the directivity characteristic (a narrow line) in the lateral direction (in the ZX plane) and the directivity characteristic (a thick line) in the longitudinal direction (in the YZ plane) in this case. In this case, as illustrated in FIG. 37, no light is emitted in directions at 45 degrees or more in the longitudinal direction, and the non-irradiation area W is dark, while the irradiation area V is bright, as in FIG. 36. Further, referring to FIG. 37, the variation in the light intensity with the angle φ is relatively smaller.

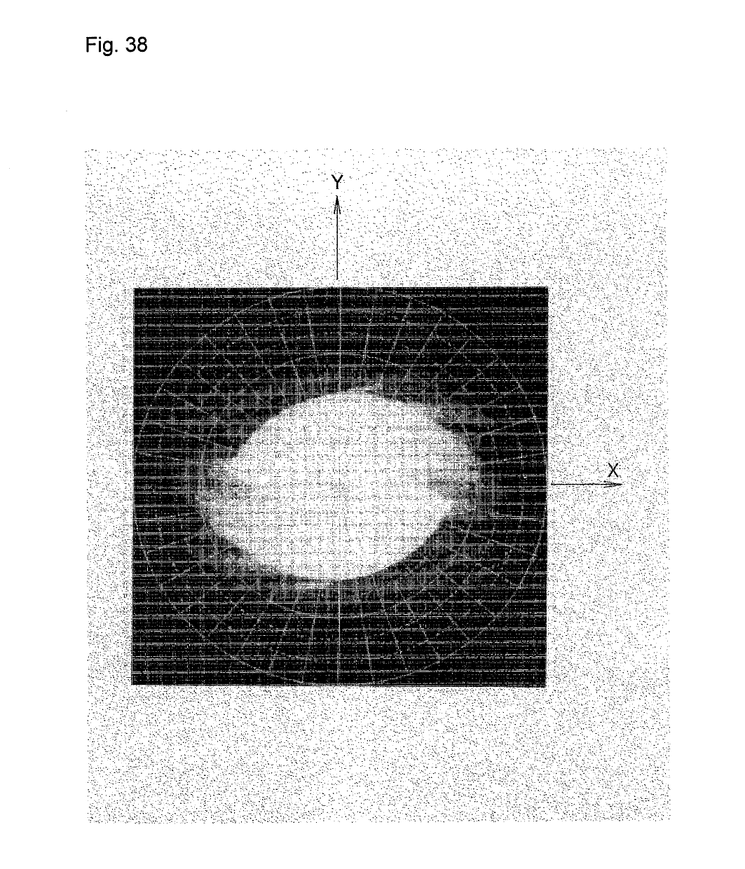

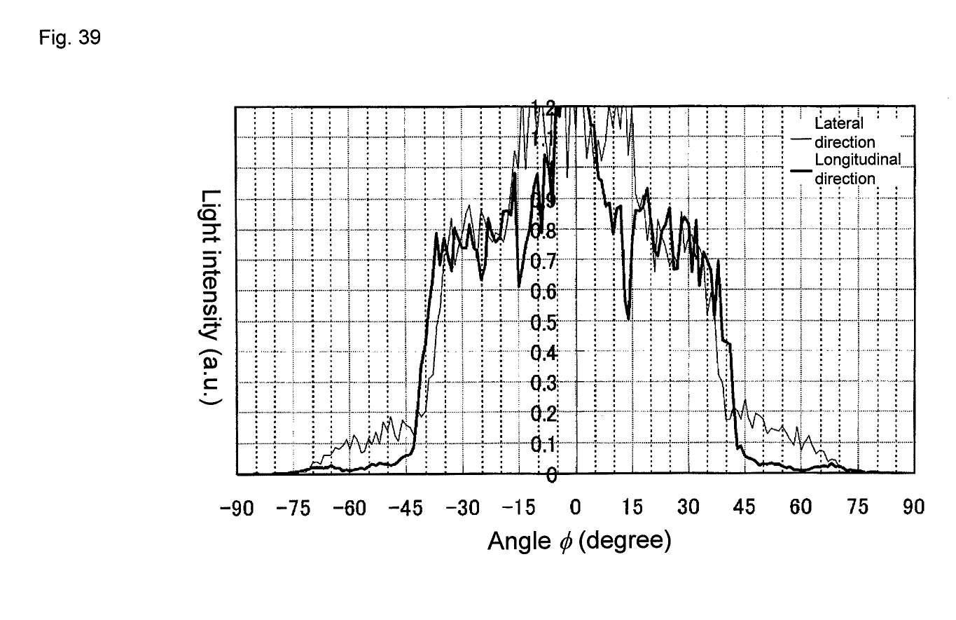

Further, FIG. 38 is a directivity characteristic diagram in a case where the prism longitudinal direction of the input-side prism sheet 12 and the prism longitudinal direction of the output-side prism sheet 13 are placed to form an angle of 15 degrees and, also, the prism longitudinal direction of the input-side prism sheet 12 is made parallel with the X direction. Further, FIG. 39 is a view illustrating the directivity characteristic (a narrow line) in the lateral direction (in the ZX plane) and the directivity characteristic (a thick line) in the longitudinal direction (in the YZ plane) in this case. In this case, as illustrated in FIG. 39, no light is emitted in directions at 45 degrees or more in the longitudinal direction, and the non-irradiation area W is dark, while the irradiation area V is bright, as in FIG. 38. Further, referring to FIG. 39, the variation in the light intensity with the angle φ is slightly increased, but the variation in the optical intensity is relatively smaller, on average.

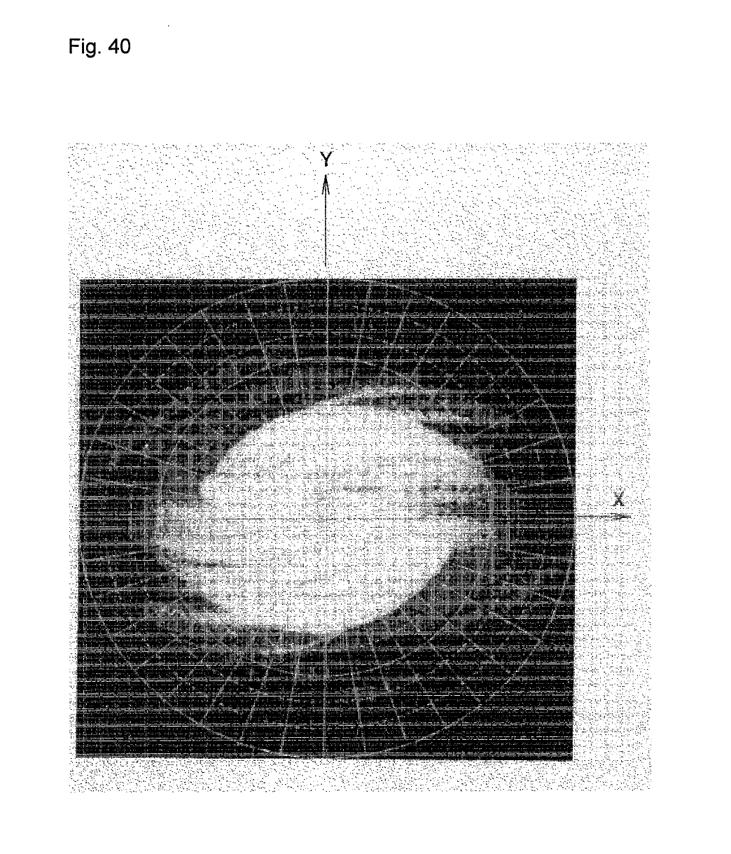

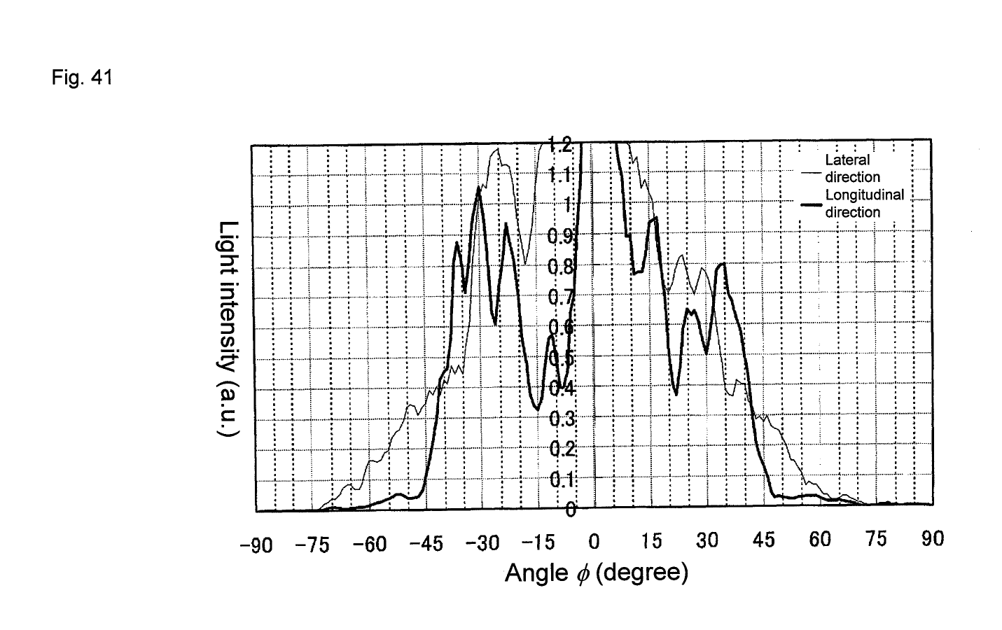

Further, FIG. 40 is a directivity characteristic diagram in a case where the prism longitudinal direction of the input-side prism sheet 12 and the prism longitudinal direction of the output-side prism sheet 13 are placed to form an angle of 20 degrees and, also, the prism longitudinal direction of the input-side prism sheet 12 is made parallel with the X direction. Further, FIG. 41 is a view illustrating the directivity characteristic (a narrow line) in the lateral direction (in the ZX plane) and the directivity characteristic (a thick line) in the longitudinal direction (in the YZ plane) in this case. In this case, as illustrated in FIG. 41, no light is emitted in directions at 45 degrees or more in the longitudinal direction, and the non-irradiation area W is dark, while the irradiation area V is bright, as in FIG. 40. Further, referring to FIG. 41, the variation in the light intensity with the angle φ is largely increased, thereby inducing luminance unevenness in the surface light source device 10.

Accordingly, it is desirable that the prism longitudinal direction of the input-side prism sheet 12 and the prism longitudinal direction of the output-side prism sheet 13 are made to form an angle of 15 degrees or less.

### Second Embodiment

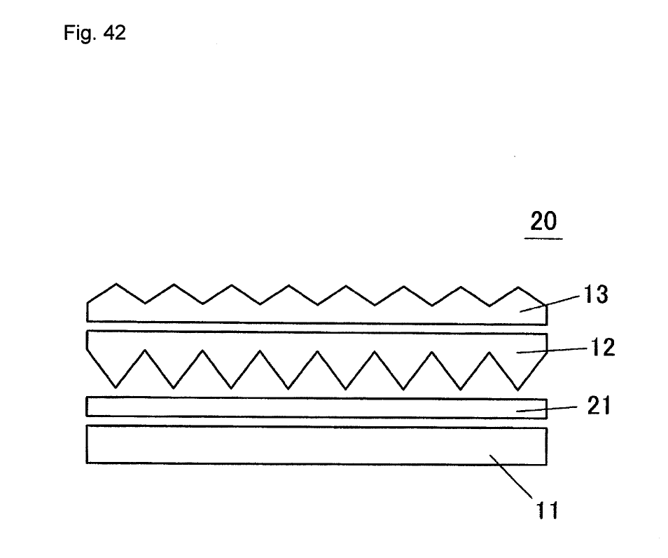

FIG. 42 is a schematic cross-sectional view illustrating a surface light source device 20 according to a second embodiment. In the present embodiment, a diffusion sheet 21 is provided between an input-side prism sheet 12 and a surface-shaped light source 11. In this case, it is possible to provide a directivity characteristic widened in the lateral direction (the X direction), due to the diffusion function of the diffusion sheet 21.

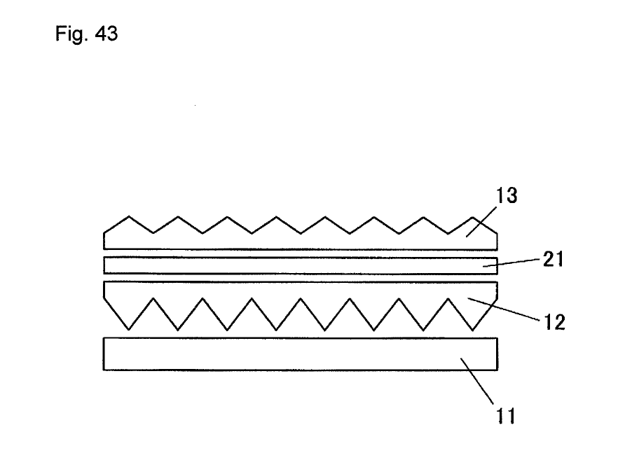

Further, as illustrated in FIG. 43, the diffusion sheet 21 can be provided between the input-side prism sheet 12 and the output-side prism sheet 13. In this case, it is possible to prevent the occurrence of optical coupling and moire fringes between the input-side prism sheet 12 and the output-side prism sheet 13, in addition to widening the directivity characteristic in the lateral direction. Further, in this case, it is preferable to employ, as the diffusion sheet 21, a diffusion sheet having a week diffusion function enough not to degrade the directivity characteristics provided by the prism sheets 12 and 13 as described in the first embodiment.

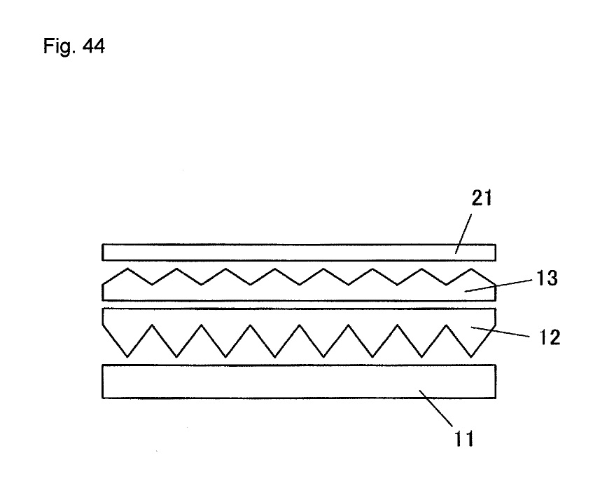

Also, as illustrated in FIG. 44, the diffusion sheet 21 can be placed on the side of the output-side prism sheet 13 which is farther from the surface-shaped light source 11. In this case, it is possible to prevent the occurrence of moire fringes between the output-side prism sheet 13 and the liquid crystal panel, in addition to widening the directivity characteristic in the lateral direction. In this case, similarly to that illustrated in FIG. 43, it is possible to employ, as the diffusion sheet 21, a diffusion sheet having a week diffusion function.

Further, as the diffusion sheet 21, it is possible to employ one having both a polarization function and a diffusion function, such as “DBEF-D” manufactured by Sumitomo 3M limited.

### Third Embodiment

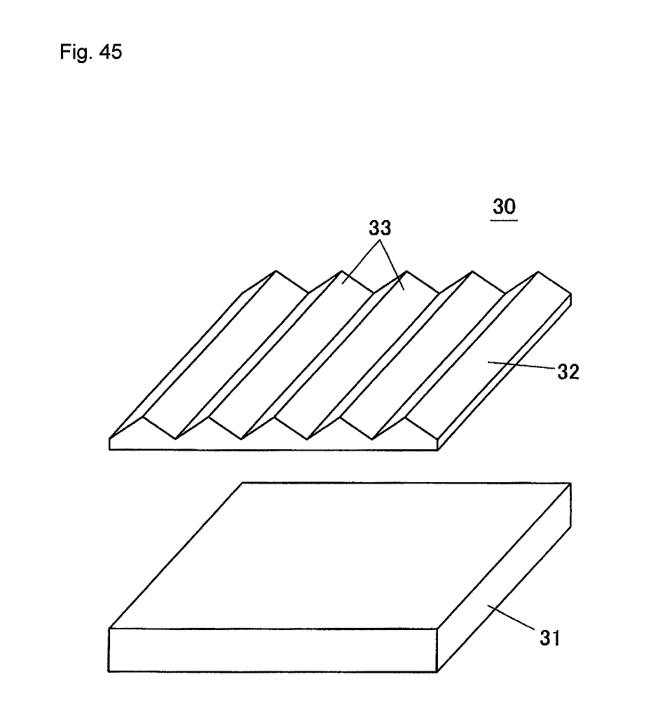

FIG. 45 is a schematic cross-sectional view illustrating a surface light source device 30 according to a third embodiment of the present invention. The surface light source device 30 is constituted by a surface-shaped light source 31 and a prism sheet 32. The prism sheet 32 is constituted by fine unit prisms 33 each having an apical angle in the range of 100 degrees to 125 degrees which are arranged on one surface thereof. Further, the unit prisms 33 have a refractive index of 1.55 or more. Particularly, the prism sheet 32 is desirably the same as the output-side prism sheet 13 described in the first embodiment. The surface-shaped light source 31 has such a directivity characteristic as to have a peak outside the range of −10 degrees to +10 degrees with respect to the vertical direction (preferably, it emits no light in the range of −10 degrees to +10 degrees) in the YZ plane containing the vertical direction (the Z direction) and a direction (the Y direction) parallel with the surface. Further, the surface-shaped light source 31 emits light having a wide directivity characteristic in the X direction which is perpendicular to the YZ plane. The prism sheet 32 is placed such that its prism-formation surface is faced toward the opposite side from the surface-shaped light source 31 and, also, its longitudinal direction is oriented in the X direction.

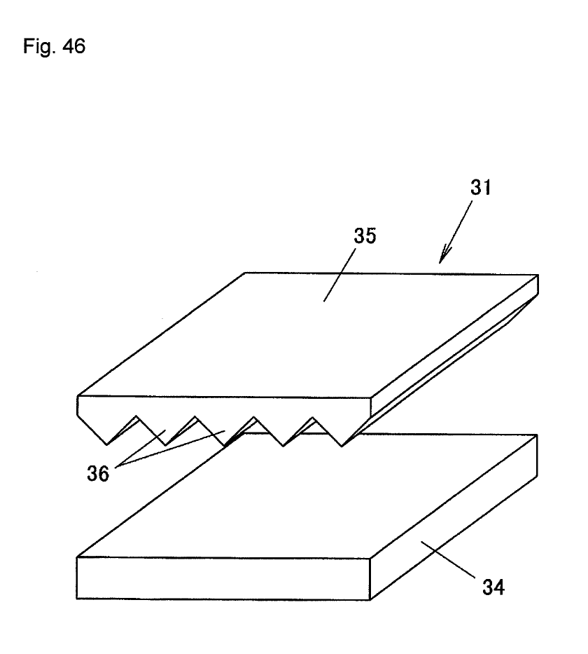

FIG. 46 is a perspective view illustrating an example of the structure of the surface-shaped light source 31. The surface-shaped light source 31 is constituted by a surface-shaped light source 34 and a prism sheet 35. The surface-shaped light source 34 is required only to be capable of substantially uniformly emitting light from a light emission surface at its front surface and, for example, can have the same structure as that of the surface-shaped light source 11 according to the first embodiment. The prism sheet 35 is constituted by fine unit prisms 36 each having an apical angle in the range of 72 degrees to 100 degrees which are arranged on one surface thereof, and is placed such that its prism-formation surface is faced to the surface-shaped light source 31, and its prism longitudinal direction is oriented in the X direction. Further, the unit prisms 36 have a refractive index of 1.55 or more. The prism sheet 35 can be the same as the input-side prism sheet 12 in the first embodiment.

The surface light source device 30 according to the third embodiment is constituted by the single prism sheet 32 and the surface-shaped light source 31 and, as can be seen from the structure thereof, it has the same effects and functions as those of the surface light source device 10 according to the first embodiment.

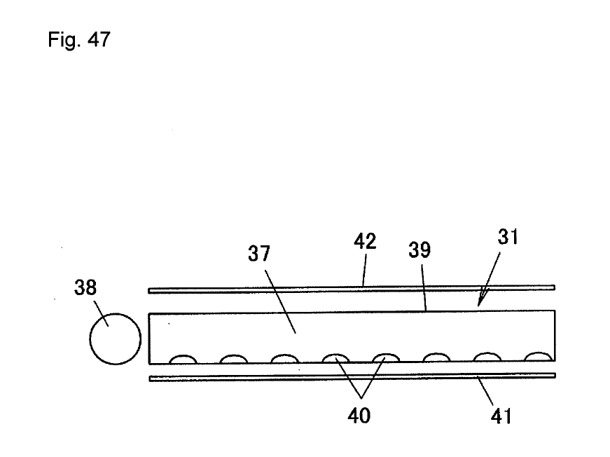

As a matter of course, the surface-shaped light source 31 having such a directivity characteristic as to have a peak outside the range of −10 degrees to +10 degrees with respect to the vertical direction can have a different structure from that of the surface-shaped light source 11 and the input-side prism sheet 12. FIG. 47 is a schematic cross-sectional view illustrating the structure of a different surface-shaped light source 31. This surface-shaped light source 31 includes an optical waveguide plate 37 which is made of a transparent resin with a relatively-higher refractive index and, further, is provided, in its back surface, with fine concave portions 40 having a semispherical shape, a triangular prism shape, a pyramidal shape or other shapes for diffusing light, and also includes a light source 38 placed to be faced to an end surface of the optical waveguide plate 37. The light source 38 can be constituted by an arrangement of plural dot-shaped light sources such as LEDs or by a linear-shaped light source such as a cold-cathode tube. Further, a reflection sheet 41 is provided such that it is faced to the back surface of the optical waveguide plate 37, and a diffusion sheet 42 is placed such that it is faced to a light emission surface 39 of the optical waveguide plate 37. The reflection sheet 41 can be either a diffusion reflection sheet or a mirror-surface reflection sheet. Such a diffusion reflection sheet can be formed from a white PET, and such a mirror-surface reflection sheet can be an Ag reflection sheet or “ESR” manufactured by Sumitomo 3M limited. The diffusion sheet 42 can be eliminated, but in the case of using it, the diffusion sheet 42 is preferably one having a haze value of 90% or less, in order to prevent excessive reduction of the luminance. With the aforementioned surface-shaped light source 31, it is possible to control the direction of emitted light, by controlling the shape and the placement of the concave portions 40.

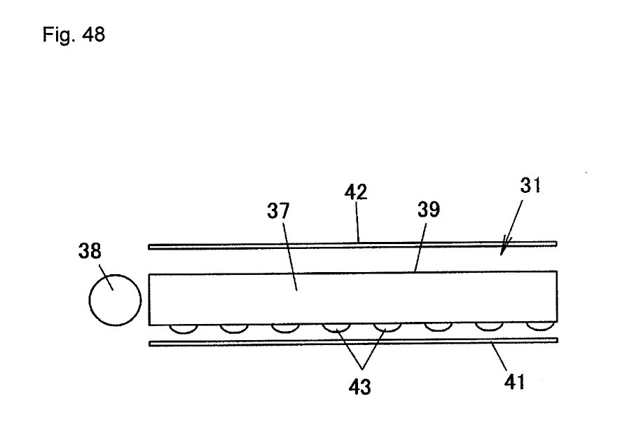

In the surface-shaped light source 31, as illustrated in FIG. 48, it is possible to provide fine convex portions 43 having a semispherical shape, a triangular prism shape, a pyramidal shape or other shapes, instead of the concave portions 40 illustrated in FIG. 47.

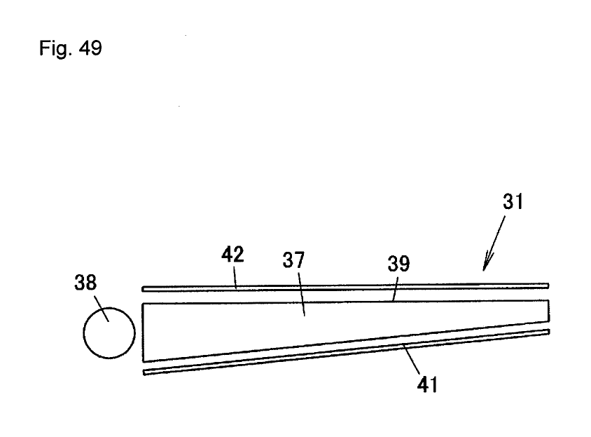

Further, as in a surface-shaped light source 31 illustrated in FIG. 49, the optical waveguide plate 37 can be a wedge-shaped optical waveguide having gradually-decreasing thicknesses at its side farther from the light source 38. In this case, there is no need for providing concave portions 40 or convex portions 43 on the back surface of the optical waveguide plate 37. Light emitted from the wedge-shaped optical waveguide plate 37 has a narrow directivity in the cross section illustrated in FIG. 49 and has a wide directivity in a plane perpendicular to the cross section of FIG. 49 and to the light emission surface. Accordingly, it is possible to provide a desired directivity characteristic, by widening the directivity characteristic using the diffusion sheet 42 (or by bending the direction of the peak in the directivity characteristic in the vertical direction using a prism sheet).

### Fourth Embodiment

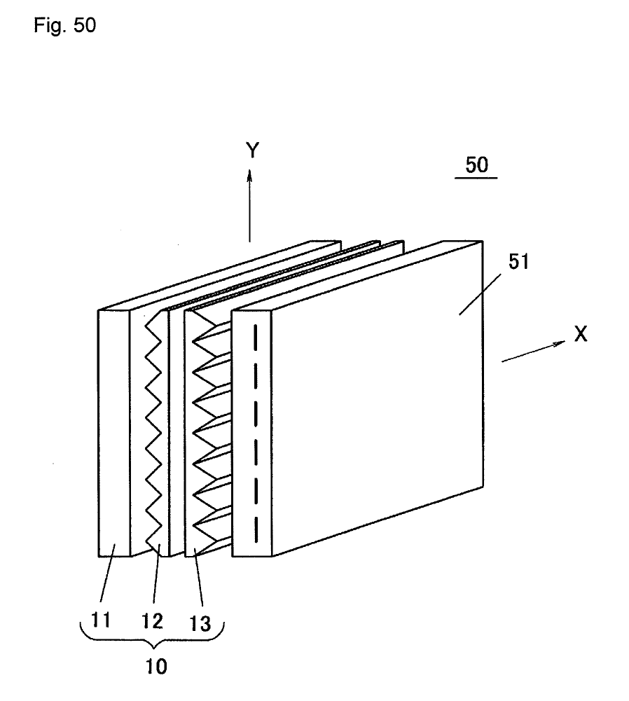

FIG. 50 is a perspective view illustrating a fourth embodiment of the present invention, illustrating a liquid crystal display device employing a surface light source device. The liquid crystal display device 50 is provided with a liquid crystal display panel 51 on the front surface of a surface light source device according to one or more embodiments of the present invention, such as the surface light source device 10 according to the first embodiment. With the liquid crystal display device, it is possible to enable viewing images in a wide range in the lateral direction (the X direction), but it is possible to enable viewing images only within a relatively-narrower range in the longitudinal direction (the Y direction). Accordingly, when it is used as an in-car monitor in a car navigation system, it is possible to enable viewing images clearly at the driving seat, the passenger seat, and the rear seats, while making images less prone to reflect on the front glass and, therefore, less prone to obstruct the driving.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A surface light source device comprising:
a surface-shaped light source having a light emission surface that emits light;
a first prism sheet placed at a side of the light emission surface of the surface-shaped light source; and
a second prism sheet placed in an opposite side from the surface-shaped light source with the first prism sheet interposed therebetween, wherein
the first prism sheet includes prisms having a greater length in a first prism longitudinal direction and having an apical angle between 72 degrees and 100 degrees which are arranged on a surface facing the surface-shaped light source,
the second prism sheet includes prisms having a greater length in a second prism longitudinal direction and having an apical angle between 100 degrees and 125 degrees which are arranged on a surface facing a direction opposite the surface-shaped light source, and
the first prism longitudinal direction of the first prism sheet and the second prism longitudinal direction of the second prism sheet form an angle of 15 degrees or less, when the first prism sheet and the second prism sheet are viewed in a direction perpendicular thereto.

2. The surface light source device according to claim 1, wherein the surface-shaped light source has such a directivity characteristic as to spread light emitted from its light emission surface.

3. The surface light source device according to claim 1, wherein the first prism sheet and the second prism sheet include prisms each having a refractive index of 1.55 or more.

4. A surface light source device comprising:
a surface-shaped light source having a light emission surface that emits light; and
a prism sheet placed at a side of the light emission surface of the surface-shaped light source, wherein
the surface-shaped light source emits, from the light emission surface, light having a directivity characteristic having a peak in a direction which forms an angle larger than 10 degrees with a direction perpendicular to the light emission surface, in a plane perpendicular to the light emission surface,
the prism sheet includes prisms having a greater length in a prism longitudinal direction and having a refractive index of 1.55 or more and an apical angle between 100 degrees and 125 degrees which are arranged on a surface facing an opposite direction from the surface-shaped light source, and
the prism sheet is placed such that the prism longitudinal direction is oriented in a direction perpendicular to the plane perpendicular to the light emission surface.

5. A liquid crystal display device comprising a liquid crystal display panel that faces the surface light source device according to claim 1.

6. A liquid crystal display device comprising a liquid crystal display panel that faces the surface light source device according to claim 4.
